(19) United States
(12) Patent Application Publication
(10) Pub. No.: US 2025/0191161 A1
(43) Pub. Date: Jun. 12, 2025

(54) INFORMATION PROCESSING METHOD AND IMAGING SYSTEM

(71) Applicant: Panasonic Intellectual Property Management Co., Ltd., Osaka (JP)

(72) Inventors: TAKAYUKI KIYOHARA, Osaka (JP); MOTOKI YAKO, Osaka (JP); HIDENOBU YAKU, Osaka (JP); CHIKAI HOSOKAWA, Osaka (JP)

(21) Appl. No.: 19/054,990

(22) Filed: Feb. 17, 2025

Related U.S. Application Data
(63) Continuation of application No. PCT/JP2023/028497, filed on Aug. 4, 2023.

(30) Foreign Application Priority Data
Sep. 8, 2022 (JP) 2022-142803
Jul. 24, 2023 (JP) 2023-119774

(51) Int. Cl. G06T 7/00; G06T 7/13; H04N 17/00; H04N 23/12; H04N 23/60; H04N 23/63

(52) U.S. Cl. CPC G06T 7/0002; G06T 7/13; H04N 17/002; H04N 23/12; H04N 23/634; H04N 23/64; G06T 2207/30168

(57) ABSTRACT

An information processing method performed using a computer, includes: acquiring a compressed image, in which information regarding wavelength bands is compressed, and identifying, based on at least one of (1) pixel values of pixels included in the compressed image, or (2) a size of a structure of a target represented by the compressed image, at least one first pixel that is included in the compressed image and that is estimated to cause a reconstruction error in images corresponding to the respective wavelength bands, the images being reconstructed from the compressed image.

### BACKGROUND

### 1. Technical Field

The present disclosure relates to an information processing method and an imaging system.

### 2. Description of the Related Art

Compressed sensing is a technique that reconstructs more data than observed data by assuming that the distribution of observation target data is sparse in a certain space, such as frequency space. Compressed sensing can be applied, for example, to an imaging device that reconstructs an image including more information from a small number of observation data. An imaging device to which compressed sensing is applied generates a reconstructed image through an operation from an image in which the spectral information of a target is compressed. As a result, various effects on images can be obtained such as higher resolution, wavelength expansion, shorter imaging time, or higher sensitivity.

U.S. Pat. No. 9,599,511 discloses an example in which compressed sensing technology is applied to a hyperspectral camera that acquires images in wavelength bands, each of which is a narrow bandwidth. According to the technology disclosed in U.S. Pat. No. 9,599,511, it is possible to realize a hyperspectral camera that generates high-resolution and multi-wavelength images.

### SUMMARY

In a case where reconstructed images are generated from images in which spectral information is compressed, it is desired to estimate reconstruction accuracy using information processing methods with relatively low computational cost.

In one general aspect, the techniques disclosed here feature an information processing method performed using a computer, including: acquiring a compressed image, in which information regarding wavelength bands is compressed, and identifying, based on at least one of (1) pixel values of pixels included in the compressed image, or (2) a size of a structure of a target represented by the compressed image, at least one first pixel that is included in the compressed image and that is estimated to cause a reconstruction error in images corresponding to the respective wavelength bands, the images being reconstructed from the compressed image.

The comprehensive or specific aspects of the present disclosure may be realized by a system, apparatus, method, integrated circuit, computer program, or recording medium such as a computer-readable recording disk, or in any combination of a system, apparatus, method, integrated circuit, computer program, and recording medium. Examples of the computer readable recording medium include a nonvolatile recording medium such as a compact disc read-only memory (CD-ROM). The apparatus may be formed by one or more devices. In a case where the apparatus is formed by two or more devices, the two or more devices may be disposed in one apparatus or may be disposed in two or more separate apparatuses in a divided manner. In this specification and the claims, an “apparatus” may refer not only to one apparatus but also to a system formed by apparatuses.

According to the technology of the present disclosure, in a case where reconstructed images are generated from images in which spectral information is compressed, reconstruction accuracy can be estimated using information processing methods with relatively low computational cost.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram schematically illustrating an example of the configuration of an imaging system;

FIG. 1B is a diagram schematically illustrating another example of the configuration of the imaging system;

FIG. 1C is a diagram schematically illustrating yet another example of the configuration of the imaging system;

FIG. 1D is a diagram schematically illustrating yet another example of the configuration of the imaging system;

FIG. 2A is a diagram schematically illustrating an example of a filter array;

FIG. 2B includes diagrams illustrating an example of a spatial distribution of optical transmittance of each of wavelength bands W₁, W₂, . . . , W_{N} included in a target wavelength range;

FIG. 2C is a diagram illustrating an example of the spectral transmittance of a region A1 included in the filter array illustrated in FIG. 2A;

FIG. 2D is a diagram illustrating an example of the spectral transmittance of a region A2 included in the filter array illustrated in FIG. 2A;

FIG. 3A is a diagram for describing an example of the relationship between a target wavelength range W and wavelength bands W₁, W₂, . . . , W_{N} included in the target wavelength range W;

FIG. 3B is another diagram for describing another example of the relationship between the target wavelength range W and the wavelength bands W₁, W₂, . . . , W_{N} included in the target wavelength range W;

FIG. 4A is a diagram for describing characteristics of the spectral transmittance of a certain region of the filter array;

FIG. 4B is a diagram illustrating a result obtained by averaging, on a wavelength band basis, the spectral transmittance of each of the wavelength bands W₁, W₂, . . . , W_{N} illustrated in FIG. 4A;

FIG. 5 is a diagram illustrating a compressed image having a reconstruction error factor and a reconstructed image of a certain wavelength band included in a hyperspectral image generated from the compressed image;

FIG. 6A is a diagram illustrating a compressed image having unsaturated pixel values, a compressed image having saturated pixel values, and the schematic distributions of pixel values in a cross-section along the horizontal direction of the two compressed images;

FIG. 6B is a diagram illustrating a reconstructed image of a certain wavelength band included in a hyperspectral image as a radial resolution chart and the distributions of pixel values in three cross-sections along the horizontal direction of the hyperspectral image;

FIG. 6C is a diagram illustrating an imaging device equipped with a filter array to which foreign matter has adhered, and a compressed image acquired by the imaging device;

FIG. 7A is a diagram illustrating an example of reporting pixels corresponding to reconstruction error factors in a compressed image in a case where the pixel values of some pixels are saturated;

FIG. 7B is a diagram illustrating another example of reporting pixels corresponding to reconstruction error factors in a compressed image in a case where the pixel values of some pixels are saturated;

FIG. 7C is a diagram illustrating yet another example of reporting pixels corresponding to a reconstruction error factor in a compressed image in a case where the pixel values of some pixels are saturated;

FIG. 8 is a diagram illustrating an example of reporting pixels corresponding to reconstruction error factors in a compressed image in a case where the period of a structure is short;

FIG. 9 is a diagram schematically illustrating an example of the configuration of an imaging system for estimating reconstruction accuracy from a compressed image;

FIG. 10 is a flowchart schematically illustrating an example of a reconstruction accuracy estimation operation performed for a reconstruction error factor (A) by a processing circuit according to the present embodiment;

FIG. 11 is a diagram schematically illustrating an example of a display user interface for reporting corresponding pixels in Step S103 illustrated in FIG. 10;

FIG. 12A is a diagram schematically illustrating an electronic component as an example of a target;

FIG. 12B is a diagram schematically illustrating elongated components as an example of the target;

FIG. 12C is a diagram schematically illustrating square-shaped components as an example of the target;

FIG. 13 is a flowchart schematically illustrating an example of a reconstruction accuracy estimation operation performed for a reconstruction error factor (B) by the processing circuit according to the present embodiment;

FIG. 14A is a diagram for describing a method for determining whether or not foreign matter has adhered to the filter array;

FIG. 14B is a diagram for describing the method for determining whether or not foreign matter has adhered to the filter array;

FIG. 14C is a diagram for describing the method for determining whether or not foreign matter has adhered to the filter array;

FIG. 15 is a flowchart schematically illustrating an example of a reconstruction accuracy estimation operation performed for a reconstruction error factor (C) by the processing circuit according to the present embodiment;

FIG. 16A is a flowchart schematically illustrating an example of the operation performed by the processing circuit according to Modification 1 of the present embodiment;

FIG. 16B is a flowchart schematically illustrating an example of the operation performed by the processing circuit according to Modification 2 of the present embodiment;

FIG. 16C is a flowchart schematically illustrating an example of the operation performed by the processing circuit according to Modification 3 of the present embodiment;

FIG. 16D is a flowchart schematically illustrating an example of the operation performed by the processing circuit according to Modification 4 of the present embodiment; and

FIG. 16E is a flowchart schematically illustrating an example of the operation performed by the processing circuit according to Modification 5 of the present embodiment.

### DETAILED DESCRIPTIONS

In the present disclosure, all or some of circuits, units, apparatuses, members, or portions or all or some of the functional blocks of a block diagram may be executed by, for example, one or more electronic circuits including a semiconductor device, a semiconductor integrated circuit (IC), or a large-scale integration circuit (LSI). The LSI or the IC may be integrated onto one chip or may be formed by combining chips. For example, functional blocks other than a storage device may be integrated onto one chip. In this case, the term LSI or IC is used; however, the term(s) to be used may change depending on the degree of integration, and the term system LSI, very large-scale integration circuit (VLSI), or ultra-large-scale integration circuit (ULSI) may be used. A field-programmable gate array (FPGA) or a reconfigurable logic device that allows reconfiguration of interconnection inside the LSI or setup of a circuit section inside the LSI can also be used for the same purpose, the FPGA and the RLD being programmed after the LSIs are manufactured.

Furthermore, functions or operations of all or one or more of the circuits, the units, the devices, the members, or the portions can be executed through software processing. In this case, the software is recorded in one or more non-transitory recording media, such as a read-only memory (ROM), an optical disc, or a hard disk drive, and when the software is executed by a processing device (a processor), the function specified by the software is executed by the processing device and peripheral devices. The system or the apparatus may include the one or more non-transitory recording media in which the software is recorded, the processing device (the processor), and a hardware device to be needed, such as an interface.

In the present disclosure, “light” refers not only to visible light (wavelengths from about 400 nm to about 700 nm) but also to electromagnetic waves including ultraviolet rays (wavelengths from about 10 nm to about 400 nm) and infrared rays (wavelengths from about 700 nm to about 1 mm).

In the following, examples of embodiments of the present disclosure will be described. Note that any one of the embodiments to be described below is intended to represent a general or specific example. The numerical values, shapes, constituent elements, arrangement positions and connection forms of the constituent elements, steps, and the order of steps are examples, and are not intended to limit the present disclosure. Among the constituent elements of the following embodiments, constituent elements that are not described in independent claims representing the most generic concept will be described as optional constituent elements. Each diagram is a schematic diagram and is not necessarily precisely illustrated. Furthermore, in each diagram, substantially the same or similar constituent elements are denoted by the same reference signs. Redundant description may be omitted or simplified.

Before describing the embodiments of the present disclosure, the findings underlying the present disclosure will be described.

The process of classifying targets present in images by type in the field of imaging is used in fields, such as factory automation (FA) and medicine. Examples of features used in the classification process include spectral information regarding the targets as well as the shapes of the targets. Since hyperspectral cameras can acquire multi-wavelength images that include a large amount of spectral information on a pixel basis, the use of hyperspectral cameras is expected in the future. Although research and development of hyperspectral cameras has been conducted worldwide for many years, their use has been limited for the following reasons. For example, line-scan hyperspectral cameras provide high spatial and wavelength resolution, but take longer to capture images due to line scanning. Snapshot hyperspectral cameras can capture images in a single shot, but often lack sufficient sensitivity and spatial resolution.

In contrast, it has recently been reported that the sensitivity and spatial resolution of hyperspectral cameras can be improved by reconstructing images on the basis of sparsity. Sparsity is the property that the elements characterizing an observation target are present in a certain space, such as frequency space, in a sparse manner. Sparsity is widely observed in the natural world. The use of sparsity makes it possible to efficiently observe necessary information. Sparsity-based sensing technology is called compressed sensing. Compressed sensing technology can be used to construct highly efficient devices and systems.

As a specific application example of compressed sensing technology, a hyperspectral camera with improved wavelength resolution has been proposed, as disclosed in U.S. Pat. No. 9,599,511, for example. Such hyperspectral cameras are equipped, for example, with optical filters that have irregular optical transmission characteristics with respect to space, wavelength, or both. Such optical filters are also referred to as “encoding masks”. An encoding mask is disposed along an optical path of light incident on an image sensor and transmits the incident light from the target so as to have region-dependent optical transmission characteristics. This process performed by the encoding mask is referred to as “encoding”. The spectral information regarding the target is compressed in the image of the target acquired through the encoding mask. The image is referred to as a “compressed image”. Mask information indicating the optical transmittance characteristics of the encoding mask is stored in advance in the memory device as a reconstruction table.

The processing device of the imaging device performs a reconstruction process on the basis of the compressed image and the reconstruction table. The reconstruction process retrieves more information, such as higher resolution image information or image information covering more wavelengths, than the compressed image contains. The reconstruction table may be, for example, data representing the spatial distribution of the optical response characteristics of the encoding mask. The reconstruction process based on such a reconstruction table can generate reconstructed images, which correspond to the respective wavelength bands included in the target wavelength range, from a single compressed image. In the following description, “reconstructed images” are also referred to simply as “reconstructed images”.

Since compressed sensing technology generates reconstructed images from compressed images, the reconstruction accuracy of the reconstructed images will be low in a case where information necessary for computation is missing in the compressed images. Since low reconstruction accuracy affects analysis accuracy, as a countermeasure, a method for estimating the reconstruction accuracy of the reconstructed images by comparing the reconstructed images with the correct images generated using a different method from the compressed sensing technology has been reported. This method generates reconstructed images from compressed images to estimate reconstruction accuracy, and thus leading to the issue of higher computational cost.

The inventor considered the above issue and conceived of the information processing method according to the embodiments of the present disclosure, which can estimate, at a relatively low computational cost, reconstruction accuracy in a case where reconstructed images are generated from compressed images. In this information processing method, the reconstruction accuracy is estimated on the basis of the lack of information in a compressed image itself, which correlates to the reconstruction accuracy. Thus, the reconstruction accuracy can be estimated at a relatively low computational cost without needing to generate reconstructed images from compressed images.

### Embodiments

In the following, first, an imaging system that generates reconstructed images from compressed images will be described. Next, a method for estimating reconstruction accuracy from compressed images will be described.

### 1. Imaging System

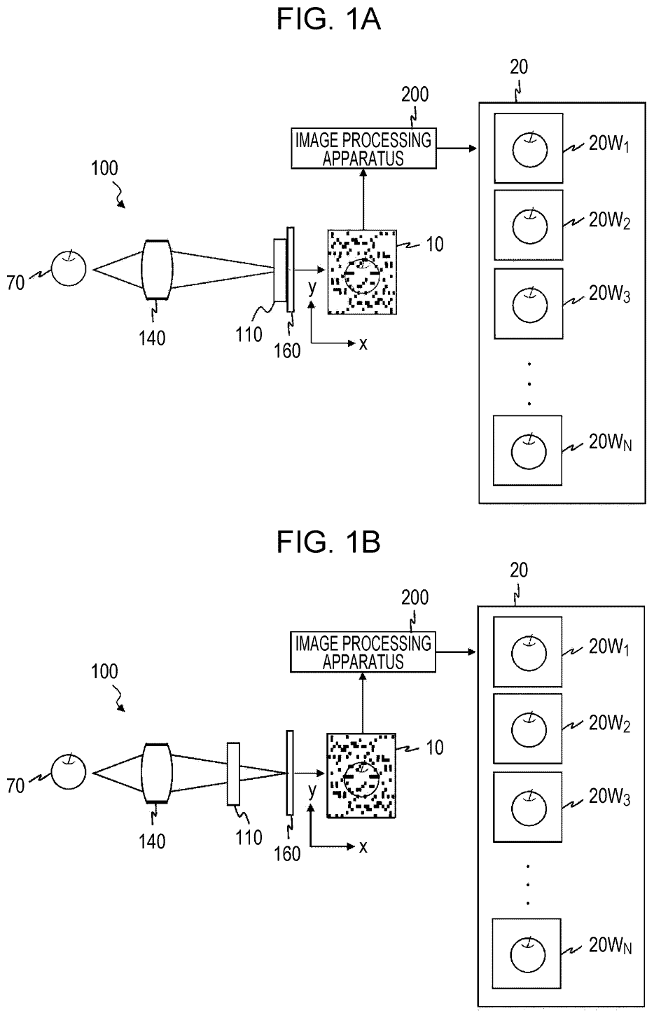

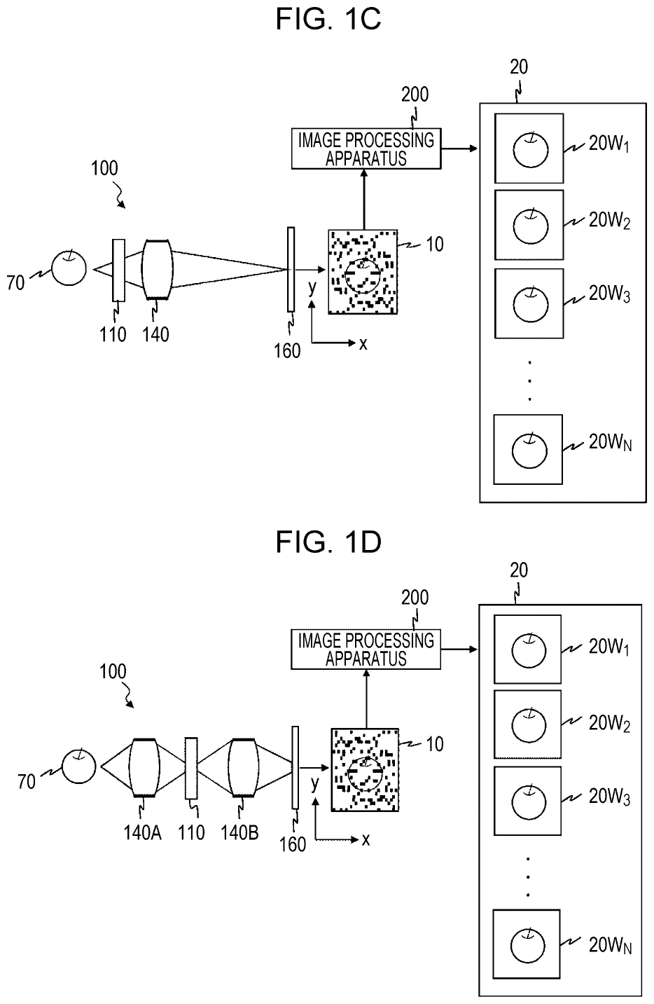

FIG. 1A is a diagram schematically illustrating an example of the configuration of an imaging system. The system illustrated in FIG. 1A includes an imaging device 100 and an image processing apparatus 200. The imaging device 100 has substantially the same configuration as the imaging device disclosed in U.S. Pat. No. 9,599,511. The imaging device 100 includes an optical system 140, a filter array 110, and an image sensor 160. The optical system 140 and the filter array 110 are disposed along an optical path of incident light from a target 70, which is a subject. The filter array 110 in the example illustrated in FIG. 1A is disposed between the optical system 140 and the image sensor 160.

FIG. 1A illustrates an apple as an example of the target 70. The target 70 is not limited to an apple, and may be any object. The image sensor 160 generates data of a compressed image 10, which is obtained by compressing information regarding wavelength bands into a two-dimensional monochrome image. The image processing apparatus 200 generates data representing images that correspond one-to-one to wavelength bands included in a predetermined target wavelength range, on the basis of the data of the compressed image 10 generated by the image sensor 160. In this case, suppose that the number of wavelength bands included in the target wavelength range is N (N is an integer greater than or equal to four). In the following description, N images generated on the basis of the compressed image 10 are referred to as reconstructed images 20W₁, 20W₂, . . . , 20W_{N}, and these images may also be referred to collectively as a “hyperspectral image 20”.

The filter array 110 in the present embodiment is an array of filters arranged in rows and columns and having translucency. The filters include different kinds of filters having different spectral transmittances from each other, that is, having different wavelength dependencies on optical transmittance from each other. The filter array 110 modulates the intensity of incident light on a wavelength basis and outputs the resulting light. This process performed by the filter array 110 will be referred to as “encoding”, and the filter array 110 will be also referred to as a “coding element”.

In the example illustrated in FIG. 1A, the filter array 110 is disposed near or directly on the image sensor 160. In this case, “near” refers to the filter array 110 being close enough to the image sensor 160 that an image of light from the optical system 140 is formed on the surface of the filter array 110 in a state where the image of light has a certain degree of clearness. “Directly on” refers to the filter array 110 and the image sensor 160 being close to each other to an extent that there is hardly any gap therebetween. The filter array 110 and the image sensor 160 may be formed as a single device.

The optical system 140 includes at least one lens. In FIG. 1A, the optical system 140 is illustrated as one lens; however, the optical system 140 may be a combination of lenses. The optical system 140 forms an image on an imaging surface of the image sensor 160 through the filter array 110.

The filter array 110 may be disposed so as to be spaced apart from the image sensor 160. FIGS. 1B to 1D are diagrams illustrating examples of the configuration of the imaging device 100, in which the filter array 110 is disposed so as to be spaced apart from the image sensor 160. In the example illustrated in FIG. 1B, the filter array 110 is disposed between the optical system 140 and the image sensor 160 and at a position spaced apart from the image sensor 160. In the example illustrated in FIG. 1C, the filter array 110 is disposed between the target 70 and the optical system 140. In the example illustrated in FIG. 1D, the imaging device 100 includes two optical systems 140A and 140B, and the filter array 110 is disposed between the optical systems 140A and 140B. As in these examples, an optical system including one or more lenses may be disposed between the filter array 110 and the image sensor 160.

The image sensor 160 is a monochrome light detector having light detection devices (also referred to as “pixels” in this specification) arranged two-dimensionally. The image sensor 160 may be, for example, a charge-coupled device (CCD), a complementary metal-oxide-semiconductor (CMOS) sensor, or an infrared array sensor. The light detection devices include, for example, a photodiode. The image sensor 160 is not necessarily a monochrome sensor. For example, color sensors may be used. A color sensor may include, for example, red (R) filters transmitting red light, green (G) filters transmitting green light, and blue (B) filters transmitting blue light. A color sensor may further include IR filters that transmit infrared light. Moreover, a color sensor may include transparent filters that transmit all red, green, and blue light. The use of a color sensor can increase the amount of information regarding wavelengths and improve the reconstruction accuracy of the hyperspectral image 20. A wavelength region as an acquisition target may be freely determined. The wavelength region is not limited to the visible wavelength region and may also be the ultraviolet wavelength region, the near infrared wavelength region, the mid-infrared wavelength region, or the far-infrared wavelength region.

The image processing apparatus 200 is a computer including one or more processors and one or more storage media, such as a memory. The image processing apparatus 200 generates data of reconstructed images 20W₁, 20W₂, . . . , 20W_{N} on the basis of the compressed image 10 acquired by the image sensor 160.

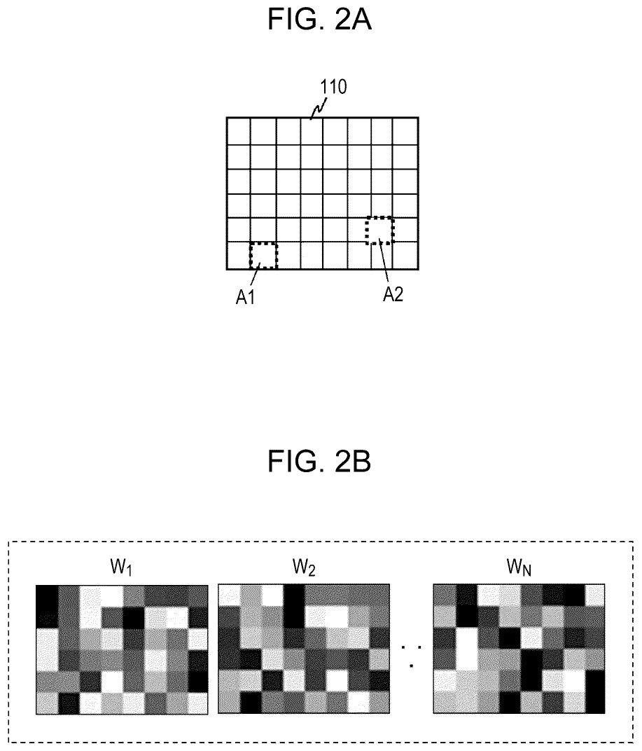

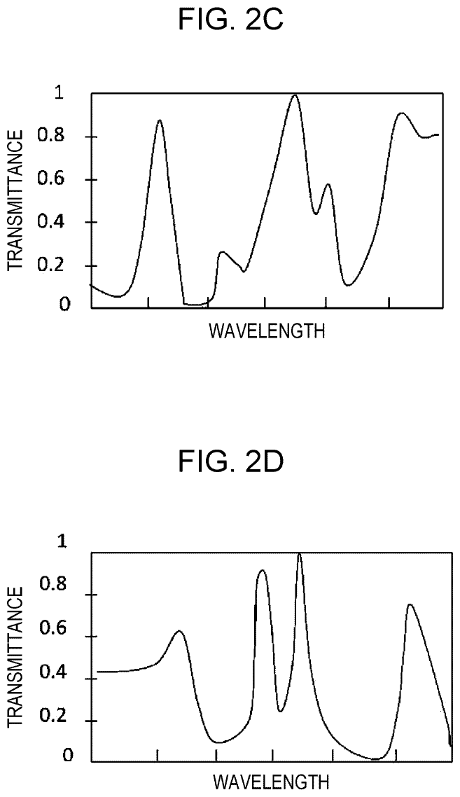

FIG. 2A is a diagram schematically illustrating an example of the filter array 110. The filter array 110 has regions arranged two-dimensionally. In this specification, these regions may be referred to as “cells”. In each region, an optical filter having a spectral transmittance set individually is disposed. Spectral transmittance is expressed by a function T(λ), where the wavelength of incident light is λ. The spectral transmittance T(λ) may have a value greater than or equal to 0 and less than or equal to 1.

In the example illustrated in FIG. 2A, the filter array 110 has 48 rectangular regions arranged in 6 rows and 8 columns. This is merely an example, and a larger number of regions than this may be provided in actual applications. The number of regions may be about the same as, for example, the number of pixels of the image sensor 160. The number of filters included in the filter array 110 is determined in accordance with applications, for example, within a range from several tens to several tens of millions.

FIG. 2B includes diagrams illustrating an example of a spatial distribution of optical transmittance of each of wavelength bands W₁, W₂, . . . , W_{N} included in the target wavelength range. In the example illustrated in FIG. 2B, differences in shading between the regions represent differences in transmittance. The lighter the shade of the region, the higher the transmittance. The darker the shade of the region, the lower the transmittance. As illustrated in FIG. 2B, the spatial distribution of optical transmittance differs on a wavelength band basis.

FIG. 2C is a diagram illustrating an example of the spectral transmittance of a region A1, and FIG. 2D is a diagram illustrating an example of the spectral transmittance of a region A2, the regions A1 and A2 being included in the filter array 110 illustrated in FIG. 2A. The spectral transmittance of the region A1 is different from that of the region A2. In this manner, the spectral transmittance of the filter array 110 differs on a region basis. Note that all the regions do not necessarily have different spectral transmittances from each other. At least some of the regions included in the filter array 110 have different spectral transmittances from each other. The filter array 110 includes two or more filters that have different spectral transmittances from each other. In one example, the number of patterns of spectral transmittances of the regions included in the filter array 110 may be the same as N, which is the number of wavelength bands included in the target wavelength range, or higher than N. The filter array 110 may be designed such that more than half of the regions have different spectral transmittances from each other.

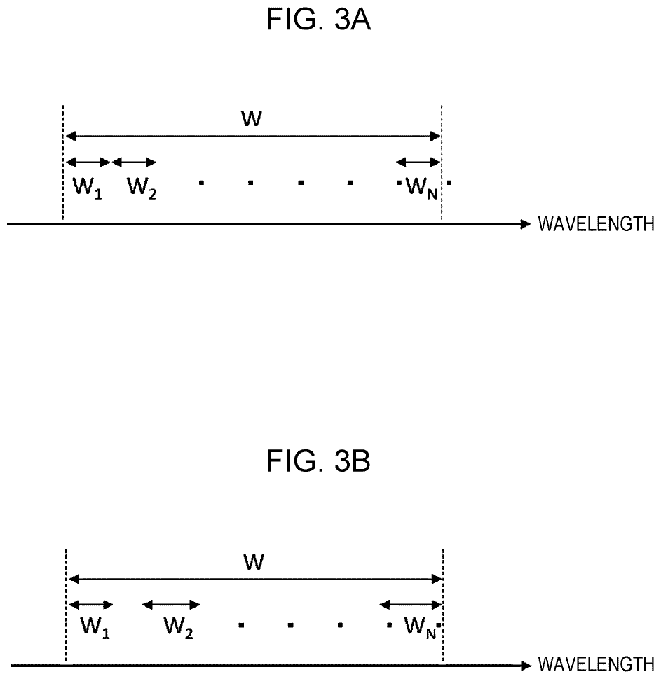

FIGS. 3A and 3B are diagrams for describing the relationships between a target wavelength range W and wavelength bands W₁, W₂, . . . , W_{N} included in the target wavelength range W. The target wavelength range W may be set to various ranges depending on applications. The target wavelength range W may have, for example, a wavelength range of visible light of about 400 nm to about 700 nm, a wavelength range of near infrared rays of about 700 nm to about 2500 nm, or a wavelength range of near ultraviolet rays of about 10 nm to about 400 nm. Alternatively, the target wavelength range W may be a wavelength range of mid-infrared rays or a wavelength range of far-infrared rays. In this manner, the wavelength range to be used is not limited to the visible light range. In this specification, not only visible light but also radiation in general including infrared rays and ultraviolet rays will be referred to as “light”.

In the example illustrated in FIG. 3A, N is set to any integer greater than or equal to 4, the target wavelength range W is equally divided into N sections, and the N wavelength regions are referred to as the wavelength bands W₁, W₂, . . . , W_{N}. Note that the example is not limited to this one. The wavelength bands included in the target wavelength range W may be freely set. For example, the wavelength bands may have different bandwidths. There may be an overlap or a gap between adjacent wavelength bands among the wavelength bands. In the example illustrated in FIG. 3B, the wavelength bands have different bandwidths, and there is a gap between two adjacent wavelength bands among the wavelength bands. In this manner, the wavelength bands may be freely determined.

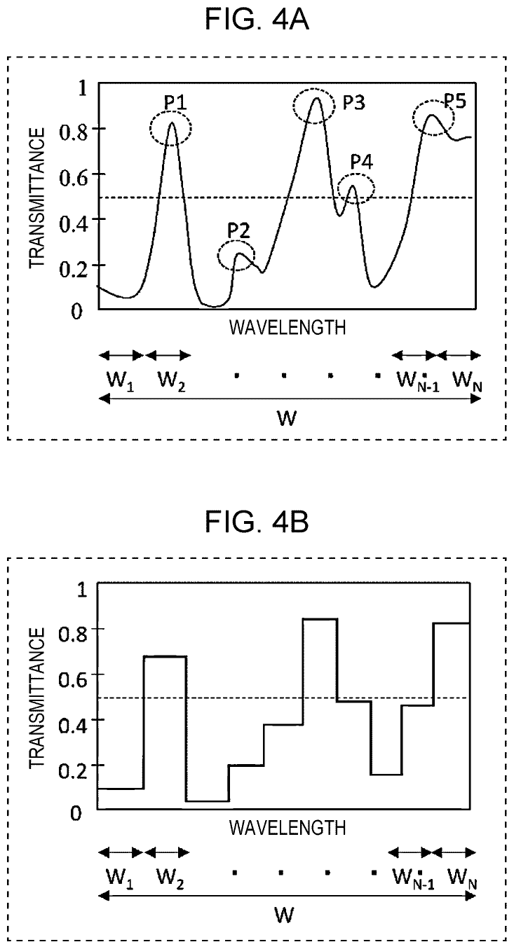

FIG. 4A is a diagram for describing characteristics of the spectral transmittance of a certain region of the filter array 110. In the example illustrated in FIG. 4A, regarding wavelengths within the target wavelength range W, the spectral transmittance has local maxima P1 to P5 and minimum values. In the example illustrated in FIG. 4A, the optical transmittance within the target wavelength range W is normalized to have a maximum value of 1 and a minimum value of 0. In the example illustrated in FIG. 4A, the spectral transmittance has local maxima in wavelength ranges such as the wavelength band W₂ and the wavelength band W_{N-1}. In this manner, the spectral transmittance of each region of at least two wavelength ranges among the wavelength bands W₁, W₂, . . . , W_{N} may be designed to have a local maximum. In the example illustrated in FIG. 4A, the local maxima P1, P3, P4, and P5 are greater than or equal to 0.5.

In this manner, the optical transmittance of each region varies with wavelength. Thus, the filter array 110 allows a large amount of a certain wavelength range component of incident light to pass therethrough but does not allow a large portion of another wavelength range component of incident light to pass therethrough. For example, the transmittance of light of k wavelength bands out of N wavelength bands may be greater than 0.5, and the transmittance of light of the other N−k wavelength ranges may be less than 0.5, where k is an integer that satisfies 2≤k<N. If incident light is white light, which includes all the visible light wavelength components equally, the filter array 110 modulates, on a region basis, the incident light into light having discrete peaks in intensity for wavelengths and superposes and outputs light of these multiple wavelengths.

FIG. 4B is a diagram illustrating, as one example, a result obtained by averaging, on a wavelength band basis, the spectral transmittance of each of the wavelength bands W₁, W₂, . . . , W_{N} illustrated in FIG. 4A. The average transmittance is obtained by integrating the spectral transmittance T(λ) on a wavelength band basis and performing division using the bandwidth of the wavelength band. In this specification, the value of average transmittance for each wavelength band obtained in this manner will be treated as the transmittance of the wavelength band. In this example, transmittance is prominently high in three wavelength ranges corresponding to the local maxima P1, P3, and P5. In particular, transmittance is higher than 0.8 in the two wavelength ranges corresponding to the local maxima P3 and P5.

In the example illustrated in FIGS. 2A to 2D, a gray scale transmittance distribution is assumed in which the transmittance of each region may have any value greater than or equal to 0 and less than or equal to 1. However, a gray scale transmittance distribution is not always needed. For example, a binary scale transmittance distribution may be used in which the transmittance of each region may have either a value of around 0 or a value of around 1. In a binary scale transmittance distribution, each region allows a large portion of light of at least two wavelength ranges among the wavelength ranges included in the target wavelength range to pass therethrough, and does not allow a large portion of light of the other wavelength ranges to pass therethrough. In this case, the “large portion” refers to about 80% or more.

Some of all the cells, for example, half the cells may be replaced with transparent regions. Such transparent regions allow light of each of the wavelength bands W₁, W₂, . . . , W_{N} included in the target wavelength range W to pass therethrough at a similarly high transmittance, for example, 80% or higher. With such a configuration, the transparent regions are disposed, for example, in a checkerboard manner. That is, the regions having optical transmittance that varies with wavelength and the transparent regions may be arranged in an alternating manner in two directions of the arrayed regions in the filter array 110.

Data representing such a spatial distribution of the spectral transmittance of the filter array 110 is acquired beforehand on the basis of design data or by performing actual measurement calibration, and is stored in a storage medium of the image processing apparatus 200. This data is used in arithmetic processing to be described later.

The filter array 110 may be formed using, for example, multi-layer films, organic materials, diffraction grating structures, metal-containing microstructures, or metasurfaces. In a case where a multi-layer film is used, for example, a dielectric multilayer film or a multi-layer film including a metal layer may be used. In this case, the cells are formed such that at least the thicknesses, materials, or stacking orders of the layers of the multi-layer film are made different from cell to cell. As a result, spectral characteristics that are different from cell to cell can be realized. By using a multi-layer film, a sharp rising edge and a sharp falling edge can be realized for spectral transmittance. A configuration using organic material can be realized by causing different cells to contain different pigments or dyes or by causing different cells to have different stacks of layers of materials. A configuration using a diffraction grating structure can be realized by causing different cells to have structures with different diffraction pitches or different depths. A metal-containing microstructure can be fabricated using plasmon effect spectroscopy. A metasurface can be fabricated by microprocessing dielectric materials in sizes smaller than the wavelength of incident light. In this structure, the refractive index to the incident light is spatially modulated. Alternatively, incident light may be encoded by directly processing the pixels included in the image sensor 160, without using the filter array 110.

From the above, it can be said that the imaging device 100 has light receiving regions having optical response characteristics different from one another. In a case where the imaging device 100 is equipped with the filter array 110 including filters and where the filters have irregularly different optical transmission characteristics from one another, the light receiving regions may be realized by the image sensor 160 with the filter array 110 that is disposed near or directly on the image sensor 160. In this case, the optical response characteristics of the light receiving regions are determined on the basis of the optical transmission characteristics of the respective filters included in the filter array 110.

Alternatively, in a case where the imaging device 100 is not equipped with the filter array 110, the light receiving regions may be realized, for example, by the image sensor 160 having pixels directly processed to have irregularly different optical response characteristics from one another. In this case, the optical response characteristics of the light receiving regions are determined on the basis of the optical response characteristics of the respective pixels included in the image sensor 160.

The above multi-layer films, organic materials, diffraction grating structures, metal-containing microstructures, or metasurfaces can encode incident light in a case where they are in a configuration in which spectral transmittance is modulated so as to vary with position in a two-dimensional plane. Thus, the above multi-layer films, organic materials, diffraction grating structures, metal-containing microstructures, or metasurfaces need not be in a configuration in which filters are disposed in an array.

Next, an example of signal processing performed by the image processing apparatus 200 will be described. The image processing apparatus 200 reconstructs a hyperspectral image 20, which is a multi-wavelength image, on the basis of the compressed image 10 output from the image sensor 160 and characteristics of a transmittance spatial distribution for each wavelength of the filter array 110. In this case, “multi-wavelength” refers to, for example, more wavelength ranges than 3-color wavelength ranges, which are RGB wavelength ranges, acquired by normal color cameras. The number of such wavelength ranges may be, for example, any number between 4 and about 100. The number of such wavelength ranges will be referred to as the “number of bands”. Depending on applications, the number of bands may exceed 100.

Data to be obtained is data of the hyperspectral image 20, and the data will be denoted by f. If the number of bands is N, f is data obtained by integrating data of N image bands f₁, f₂, . . . , f_{N}. In this case, suppose that the horizontal direction of the image is the x-direction, and the vertical direction of the image is the y-direction. When the number of pixels in the x-direction for the image data to be obtained is m, and the number of pixels in the y-direction for the image data to be obtained is n, each of the image data f₁, f₂, . . . , f_{N} has n×m pixel values. Thus, the data f is data having n×m×N elements. In contrast, data g of the compressed image 10 acquired by the filter array 110 through encoding and multiplexing has n×m elements.

The data g can be expressed by the following Eq. (1).

$$g = Hf = H [ \begin{matrix}{f}_{1} \\ {f}_{2} \\ ⋮ \\ {f}_{N}\end{matrix} ] \qquad ( 1 )$$

In Eq. (1), f represents the data of the hyperspectral image expressed as a one-dimensional vector. Each of f₁, f₂, . . . , and f_{N} has n×m elements. Thus, the vector on the right side is strictly a one-dimensional vector having n×m×N rows and one column. The data g of the compressed image is calculated as a one-dimensional vector having n×m rows and one column. A matrix H represents a conversion in which individual components f₁, f₂, . . . , f_{N} of the vector f are encoded and intensity-modulated using encoding information that varies on a wavelength band basis, and are then added to one another. Thus, H denotes a matrix having n×m rows and n×m×N columns. Eq. (1) can also be expressed as follows.

g=(pg₁₁. . . pg₁ₘ. . . pgₙ₁. . . pgₙₘ)^{T}=H(f₁. . . f_{N})^{T},

where pgᵢⱼ denotes the pixel value in the i-th row and j-th column of the compressed image 10.

When the vector g and the matrix H are given, it seems that f can be calculated by solving an inverse problem of Eq. (1). However, the number of elements (n×m×N) of the data f to be obtained is greater than the number of elements (n×m) of the acquired data g, and thus this problem is an ill-posed problem, and the problem cannot be solved as is. Thus, the image processing apparatus 200 uses the redundancy of the images included in the data f and uses a compressed sensing method to obtain a solution. Specifically, the data f to be obtained is estimated by solving the following Eq. (2).

$${f}^{′} = arg {min}_{f} \{ {‖ g - Hf ‖}_{{l}_{2}} + τΦ ( f ) \} \qquad ( 2 )$$

In this case, f denotes the data of the estimated f. The first term in the braces of the equation above represents a shift between an estimation result Hf and the acquired data g, which is a so-called residual term. In this case, the sum of squares is treated as the residual term; however, an absolute value, a root-sum-square value, or the like may be treated as the residual term. The second term in the braces is a regularization term or a stabilization term. Eq. (2) means to obtain f that minimizes the sum of the first term and the second term. The function in the braces in Eq. (2) is called the evaluation function. The image processing apparatus 200 can cause the solution to converge through a recursive iterative operation and can calculate f that minimizes the evaluation function as the final solution f.

The first term in the braces of Eq. (2) refers to a calculation for obtaining the sum of squares of the differences between the acquired data g and Hf, which is obtained by converting f in the estimation process using the matrix H. The second term Φ(f) is a constraint for regularization of f and is a function that reflects sparse information regarding estimated data. This function has the effect of making the estimated data smooth and stable. The regularization term can be expressed using, for example, discrete cosine transformation (DCT), wavelet transform, Fourier transform, or total variation (TV) of f. For example, in a case where total variation is used, stabilized estimated data can be acquired in which the effect of noise of the data g, observation data, is suppressed. The sparsity of the target 70 in the space of each regularization term differs with the texture of the target 70. A regularization term for which the texture of the target 70 becomes sparser in the space of the regularization term may be selected. Alternatively, regularization terms may be included in calculation. T is the weighting factor. The greater the weighting factor r, the greater the amount of reduction of redundant data, thereby increasing a compression rate. The smaller the weighting factor r, the lower the convergence to the solution. The weighting factor T is set to an appropriate value with which f is converged to a certain degree and is not compressed too much.

Note that, in the configurations illustrated in FIGS. 1B and 1C, images encoded by the filter array 110 are acquired in bokeh states on the imaging surface of the image sensor 160. Thus, the hyperspectral image 20 can be generated by reflecting the bokeh information in the above-described matrix H, the bokeh information being stored in advance. In this case, the bokeh information is expressed by a point spread function (PSF). The PSF is a function that defines the degree of spread of a point image to the surrounding pixels. For example, in a case where a point image corresponding to one pixel on an image is spread to a region of k×k pixels around the pixel due to bokeh, the PSF can be defined as a group of factors, that is, a matrix indicating the effect on the pixel value of each pixel in the region. The effect of bokeh on an encoding pattern caused by the PSF is reflected in the matrix H, so that the hyperspectral image 20 can be reconstructed. The filter array 110 may be disposed at any position; however, a position may be selected where the encoding pattern of the filter array 110 does not spread so much as to disappear.

Through the above-described process, the hyperspectral image 20 can be reconstructed from the compressed image 10 acquired by the image sensor 160. Details of the method for reconstructing the hyperspectral image 20 are disclosed in U.S. Pat. No. 9,599,511.

### 2. Estimation of Reconstruction Accuracy when Generating Reconstructed Images from Compressed Image

2.1. Method for Estimating Reconstruction Error Factors from Compressed Image

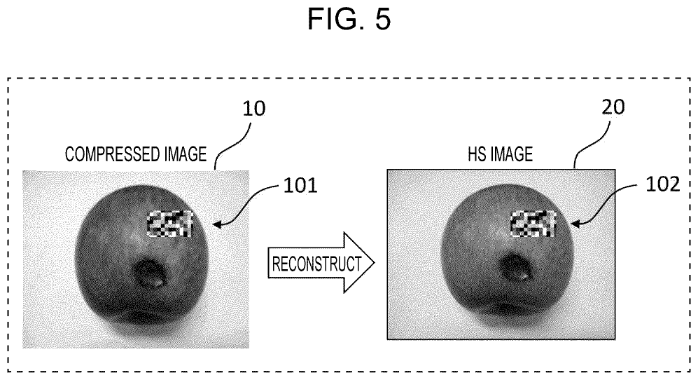

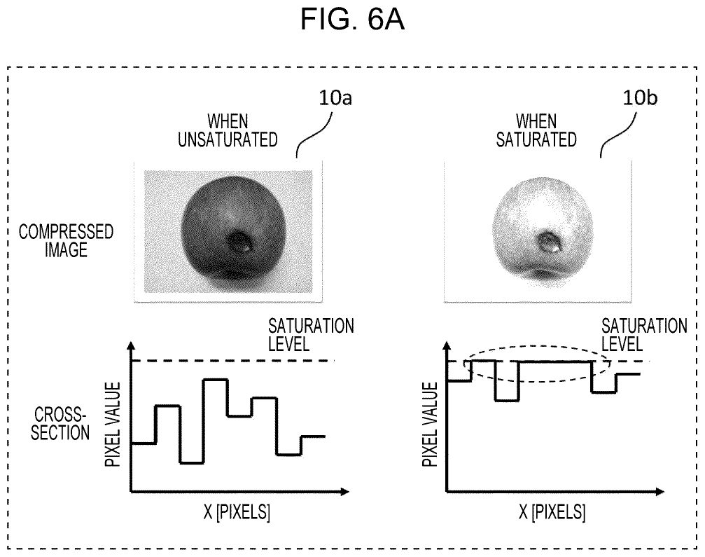

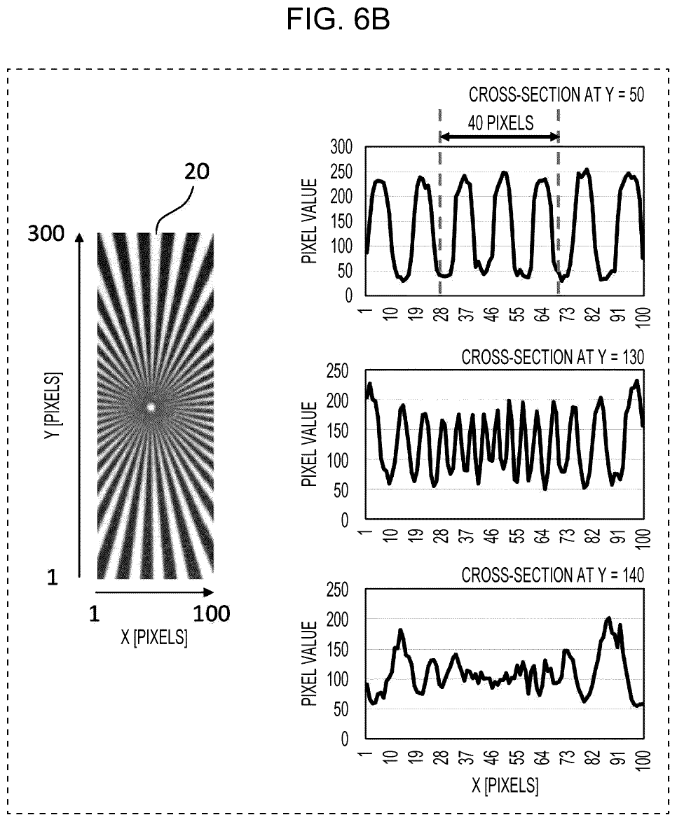

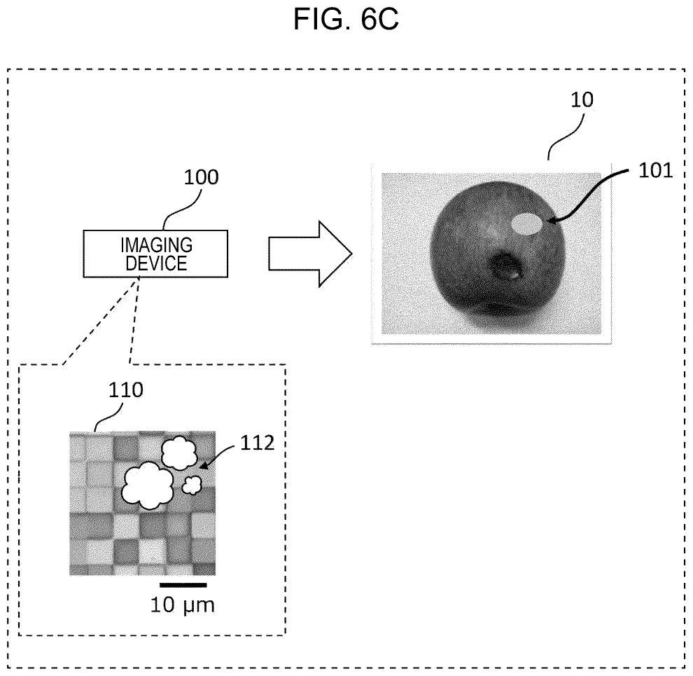

Next, a method for estimating reconstruction error factors from a compressed image will be described with reference to FIGS. 5 to 6C. FIG. 5 is a diagram illustrating the compressed image 10 having a reconstruction error factor 101 and a reconstructed image of a certain wavelength band included in the hyperspectral image 20 generated from the compressed image 10. The target is an apple. The “HS image” illustrated in FIG. 5 represents a certain reconstructed image included in the hyperspectral image 20. The reconstructed image is represented as a monochrome image. The same is true for the reconstructed images described below. As illustrated in FIG. 5, the compressed image 10 includes the reconstruction error factor 101, and thus the hyperspectral image 20 generated from the compressed image 10 includes a reconstruction error 102. As the reconstruction error factor 101 in the compressed image 10, for example, the following three factors (A) to (C) can be considered.

(A) In a case where the pixel values of some pixels included in the compressed image 10 are saturated or where the pixel values of some pixels included in the compressed image 10 are low relative to the dark noise, the reconstruction error 102 occurs in the hyperspectral image 20.

FIG. 6A is a diagram illustrating a compressed image 10a with unsaturated pixel values, a compressed image 10b containing saturated pixel values, and the schematic distributions of pixel values in a cross-section along the horizontal direction of the compressed images 10a and 10b. In the compressed image 10a illustrated in FIG. 6A, the pixel values of all pixels in a certain cross-section along the horizontal direction are lower than the saturation level represented by the dashed line and are not saturated. In contrast, in the compressed image 10b illustrated in FIG. 6A, the pixel values of some pixels in a certain cross-section along the horizontal direction have reached the saturation level and are saturated. The dashed ellipse represents portions where pixel values are saturated. Since pixel values are constant when saturated, some information necessary for the reconstruction operation is missing, resulting in the reconstruction error 102 in the hyperspectral image 20. Even in a case where the pixel values of the pixels included in the compressed image 10 are unsaturated, when the pixel values of some pixels included in the compressed image 10 are low relative to the dark noise, the signal-to-noise ratio (S/N) as a signal will decrease and the reconstruction accuracy will decrease due to the increased effect of shot noise.

(B) In a case where the structural units of the target are small relative to the compressed image 10, this violates the assumption that “the image is smooth” in the reconstruction operation, so that the reconstruction error 102 occurs in the hyperspectral image 20.

FIG. 6B is a diagram illustrating a reconstructed image of a certain wavelength band included in the hyperspectral image 20 as a radial resolution chart and the distributions of pixel values in three cross-sections along the horizontal direction of the hyperspectral image 20. The reconstructed image illustrated in FIG. 6B has 100 pixels in the X-direction and 300 pixels in the Y-direction. As Y=150 is approached, the period of the structure of the resolution chart in the X-direction becomes shorter. The reconstructed image accurately reflects the structure of the resolution chart in the X-direction at Y=50 and Y=130. In contrast, the reconstructed image does not accurately reflect the structure of the resolution chart in the X-direction at Y=140. In this manner, as the period of the structure of the resolution chart in the X-direction becomes shorter, the reconstruction error 102 occurring in the hyperspectral image 20 increases.

(C) In a case where the encoding information of the filter array 110 used to acquire the compressed image 10 is different from the encoding information of the filter array 110 at the time of shipment, the reconstruction error 102 occurs in the hyperspectral image 20 due to the inconsistency of these two pieces of encoding information. In this specification, the encoding information of the filter array 110 at the time of shipment is the encoding information of the filter array 110 obtained through calibration prior to shipment.

FIG. 6C is a diagram illustrating the imaging device 100 equipped with the filter array 110 to which foreign matter 112 has adhered, and the compressed image 10 acquired by the imaging device 100. The foreign matter 112 illustrated in FIG. 6C may be, for example, dust. In addition to dust, the foreign matter 112 may be water droplets or oil. As illustrated in FIG. 6C, when the foreign matter 112 adheres to the filter array 110, the foreign matter 112 appears as a shadow or shadows in the compressed image 10. In this case, “shadow” includes not only darkening of a portion of the compressed image 10 but also a portion of the compressed image 10 being out of focus. Shadows can be reconstruction error factors 101 and cause reconstruction errors 102 in the hyperspectral image 20.

In the information processing method according to the present embodiment, the reconstruction accuracy is estimated by determining whether or not at least one pixel included in the compressed image 10 corresponds to the reconstruction error factors (A) to (C). The reconstruction accuracy can be estimated at a relatively low computational cost since there is no need to generate the hyperspectral image 20 from the compressed image 10. The reconstruction accuracy may be estimated before the reconstruction operation for generating the hyperspectral image 20 or in parallel with the reconstruction operation.

### 2.2. Reasons for Propagation of Reconstruction Errors to Surrounding Pixels

In a case where the compressed image 10 has the reconstruction error factor 101, the reconstruction error propagates not only to the pixels corresponding to the reconstruction error factor 101 but also to their surrounding pixels. The reason for this is that in the reconstruction operation, the evaluation function expressed by Eq. (2) causes the solution to converge to a small value under the assumption that “the image is smooth”. In the second term Φ included in the evaluation function expressed by Eq. (2), for each of the pixels included in the image, the sum of the differences between the pixel value of the pixel and the pixel values of the pixels directly above, below, to the left, and to the right of the pixel is calculated. This means converging to a solution where the pixel values between adjacent pixels are smaller. Thus, when some pixels are saturated, as in the case of the reconstruction error factor (A), the reconstruction error propagates to their surrounding pixels. The same is true for the cases of the reconstruction error factors (B) and (C).

### 2.3. Notification of Estimated Reconstruction Errors

Estimating the reconstruction error factor 101 and notifying the user or the imaging system of the pixels corresponding to the reconstruction error factor 101 in the compressed image 10 will help improve the image capturing environment, such as illumination and exposure time, resulting in solving the reconstruction error factor 101. The reconstruction error factor 101 can basically be determined on a pixel-by-pixel basis. However, since it is assumed that the image is smooth in the reconstruction operation, the reconstruction error propagates to the surrounding pixels. Based on this, the pixels corresponding to the reconstruction error factor 101 may be reported. Pixels to be reported may be the following (a) to (c).
(a) Pixels corresponding to the reconstruction error factor 101
(b) The pixels corresponding to the reconstruction error factor 101 and their surrounding pixels
(c) Pixels that are connected across a certain range by being adjacent, among the pixels corresponding to the reconstruction error factor 101

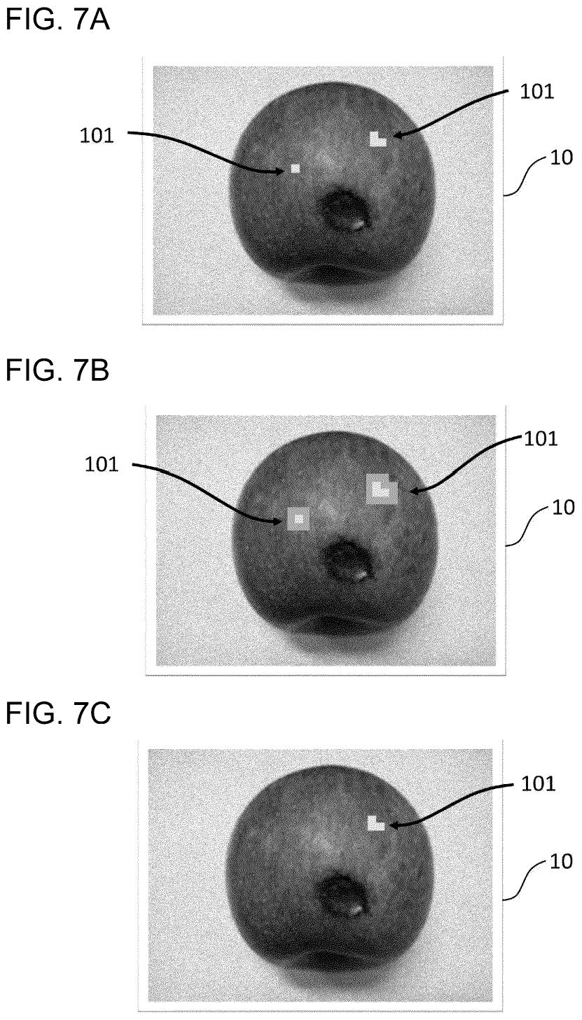

FIGS. 7A to 7C are diagrams illustrating examples of reporting the pixels corresponding to reconstruction error factors 101 in the compressed image 10 in a case where the pixel values of some pixels are saturated. In the example illustrated in FIG. 7A, as in the above (a), only the pixels corresponding to the reconstruction error factors 101 are highlighted in light gray. The number of pixels corresponding to the left reconstruction error factor 101 is one, and the pixels corresponding to the right reconstruction error factor 101 are pixels that are connected across a certain range by being adjacent. In the example illustrated in FIG. 7B, as in the above (b), the pixels corresponding to the reconstruction error factors 101 are highlighted in light gray, and their surrounding pixels are highlighted in dark gray. In the example illustrated in FIG. 7C, as in the above (c), the pixels that are connected across a certain range by being adjacent are highlighted in light gray among the pixels corresponding to the reconstruction error factors 101. In a case where pixels whose pixel values are saturated are not connected across a certain range, there may be a case where saturated pixels are complemented under the assumption that the differences in pixel value between the pixels and their surrounding pixels are smooth. In such cases, the pixels that are not connected across a certain range need not be highlighted.

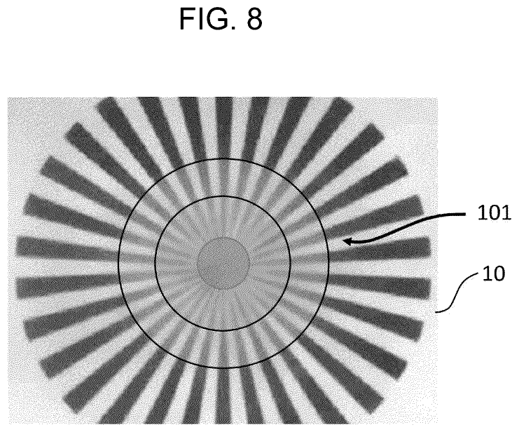

FIG. 8 is a diagram illustrating an example of reporting the pixels corresponding to reconstruction error factors 101 in the compressed image 10 in a case where the period of a structure is short. In the example illustrated in FIG. 8, in the resolution chart of the compressed image 10, the higher the spatial frequency is, the darker the pixels corresponding to the reconstruction error factors 101 are highlighted in gray.

In addition to the above colored highlighting, position information regarding the pixels corresponding to the reconstruction error factors 101 and the reconstruction error factors 101 may be output as text data. Alternatively, the exposure time and illumination conditions of a camera, for example, may be automatically adjusted as the settings of another device in an image shooting system, in order to eliminate the reconstruction error factors 101.

### 2.4. Imaging System for Estimating Reconstruction Accuracy

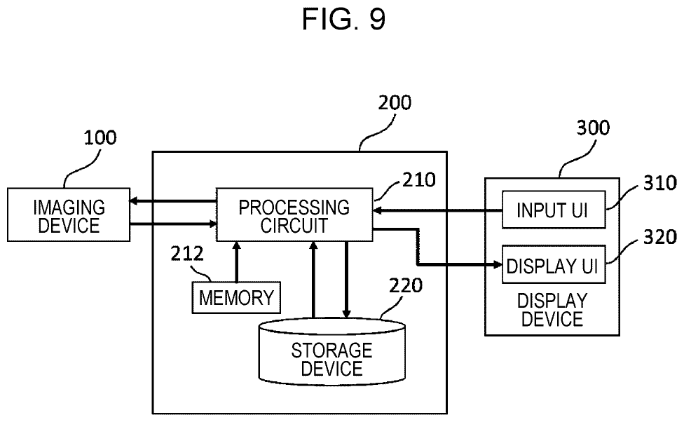

FIG. 9 is a diagram schematically illustrating an example of the configuration of an imaging system for estimating reconstruction accuracy from the compressed image 10. The imaging system illustrated in FIG. 9 includes the imaging device 100, the image processing apparatus 200, and a display device 300. Lines with arrows represent signal transmission and reception.

In the following, each structural element of the imaging system illustrated in FIG. 9 will be described. The imaging device 100 has been described with reference to FIGS. 1A to 1D.

The image processing apparatus 200 includes a processing circuit 210, a memory 212, and a storage device 220. The processing circuit 210 controls the operation of the imaging device 100, storage device 220, and display device 300. The details of a reconstruction accuracy estimation operation performed by the processing circuit 210 will be described later. A computer program executed by the processing circuit 210 is stored in the memory 212, such as a read-only memory (ROM) or a random access memory (RAM). The processing circuit 210 and the memory 212 may be integrated on one circuit board or on separate circuit boards. The processing circuit 210 may be distributed across circuits. The processing circuit 210, the memory 212, or both may be remotely located away from other structural elements via a wired or wireless communication network.

The storage device 220 includes one or more storage media. Each storage medium may be any storage medium, such as a semiconductor memory, a magnetic storage medium, or an optical storage medium, for example. The storage device 220 stores a reconstruction table. The reconstruction table is an example of encoding information indicating the optical transmission characteristics of the filter array 110, which functions as an encoding mask, and is acquired through calibration before shipment. The reconstruction table may be, for example, tabular data representing the matrix H in Eq. (2).

The display device 300 displays an input user interface (UI) 310 and a display UI 320. The input UI 310 is used by the user to input information. The information input by the user through the input UI 310 is received by the processing circuit 210. The display UI 320 is used to display estimation results of the reconstruction accuracy.

The input UI 310 and the display UI 320 are displayed as a graphical user interface (GUI). The information presented through the input UI 310 and the display UI 320 can also be said to be displayed by the display device 300. The input UI 310 and the display UI 320 may be realized by a device that allows both input and output, such as a touch screen. In such cases, the touch screen may function as the display device 300. In a case where a keyboard, a mouse, or both are used as the input UI 310, the input UI 310 is a device independent of the display device 300.

### 2.5. Reconstruction Accuracy Estimation Operation

Next, regarding the above-described reconstruction error factors (A) to (C), examples of the reconstruction accuracy estimation operation will be described.

### 2.5.1. About Reconstruction Error Factor (A)

### (a) Pixels Corresponding to Reconstruction Error Factors 101

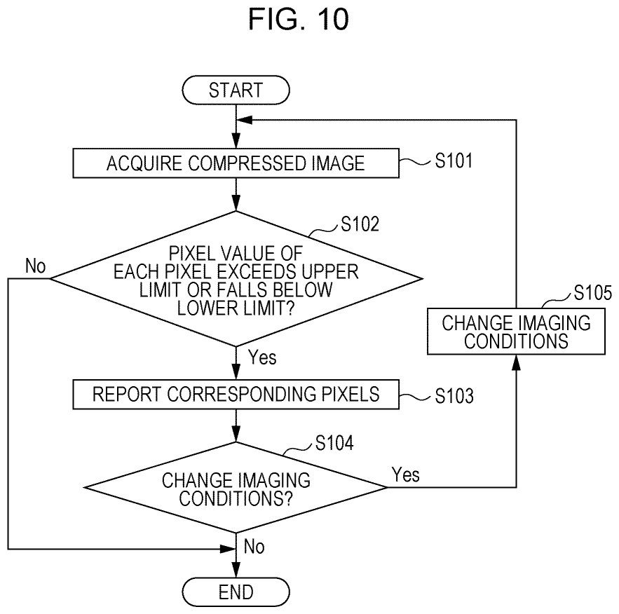

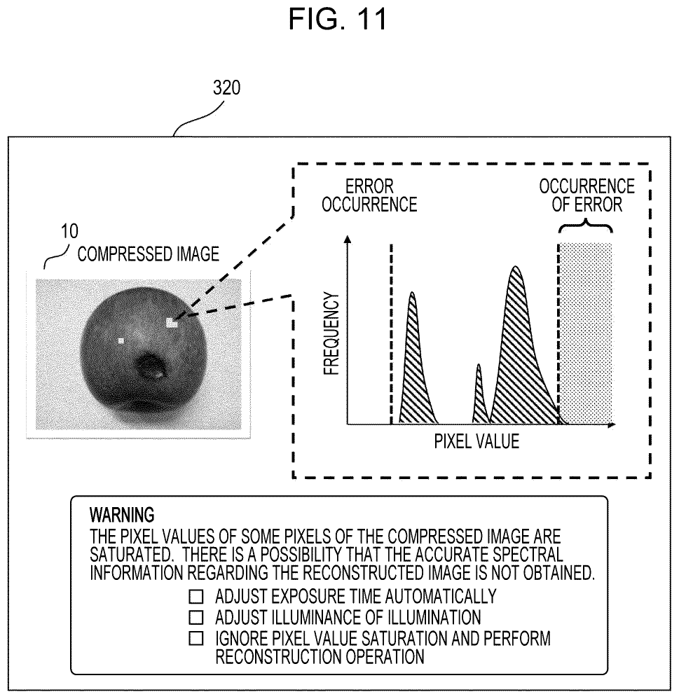

First, with reference to FIGS. 10 and 11, an example of the reconstruction accuracy estimation operation for the reconstruction error factor (A) will be described. FIG. 10 is a flowchart schematically illustrating an example of a reconstruction accuracy estimation operation performed for the reconstruction error factor (A) by the processing circuit 210 according to the present embodiment. The processing circuit 210 performs the operations in Steps S101 to S105 illustrated in FIG. 10.

### Step S101

The processing circuit 210 causes the imaging device 100 to capture a compressed image 10 of the target 70 and acquires the compressed image 10. The compressed image 10 may be, for example, a monochrome image of the target acquired by the image sensor 160 through the filter array 110. The user may input imaging conditions of the imaging device 100 through the input UI 310 before acquiring the compressed image. The imaging conditions may be, for example, at least one of the exposure time of the imaging device 100 or the illuminance of illumination.

### Step S102

The processing circuit 210 determines whether or not the pixel value of each of the pixels included in the compressed image 10 exceeds a predetermined upper limit or falls below a predetermined lower limit. In other words, the processing circuit 210 determines whether or not the compressed image 10 includes pixels whose pixel values exceed the predetermined upper limit or fall below the predetermined lower limit. In a case where the dynamic range of the imaging device 100 is 8 bits, the predetermined upper limit may be, for example, 255, and the predetermined lower limit may be, for example, 10. In a case where pixel values exceed 255, the pixel values are saturated, and in a case where pixel values fall below 10, the pixel values are lower than the dark noise. In a case where a determination of Yes is obtained, namely, where a pixel value that exceeds the predetermined upper limit is identified or a pixel value that falls below the predetermined lower limit is identified, the processing circuit 210 performs the operation in Step S103. In a case where a determination of No is obtained, namely, where a pixel value that exceeds the predetermined upper limit is not identified or a pixel value that falls below the predetermined lower limit is not identified, the processing circuit 210 terminates the processing operation for estimating reconstruction accuracy.

In this specification, about the reconstruction error factor (A), “a reconstruction error is estimated” refers to a case where one or more pixels identified on the basis of their pixel values as in the above example are determined to be included in the compressed image 10. “A reconstruction error is not estimated” refers to a case where one or more pixels identified on the basis of their pixel values as in the above example are determined not to be included in the compressed image 10.

### Step S103

The processing circuit 210 notifies the user of the corresponding pixels in the compressed image 10 through the display UI 320. The number of corresponding pixels is one or more.

### Step S104

The processing circuit 210 determines whether or not to change the imaging conditions. In a case where the imaging conditions are to be changed, the processing circuit 210 may provide an output recommending the user to adjust at least one of the exposure time of the imaging device 100, which has acquired the compressed image 10, or the illumination in the image capturing environment for acquiring the compressed image 10 through the display UI 320, for example. In order to make it possible for the user to make a determination, the processing circuit 210 may receive an input from the user through the input UI 310 to determine whether or not to change the imaging conditions. In a case where the corresponding pixels are not connected across a certain range in Step S103, the reconstruction errors do not propagate to the surrounding pixels, so that the imaging conditions need not be changed. In a case where a determination of Yes is obtained, the processing circuit 210 performs the operation in Step S105. In a case where a determination of No is obtained, the processing circuit 210 terminates the processing operation for estimating reconstruction accuracy.

### Step S105

The processing circuit 210 changes the imaging conditions. In that case, the processing circuit 210 outputs a signal to change at least one of the exposure time of the imaging device 100, which has acquired the compressed image 10, or the output of the illumination in the image capturing environment for acquiring the compressed image 10. The processing circuit 210 performs the operation in Step S101 again after the operation in Step S105.

As described above, the information processing method performed using a computer according to the present embodiment includes the following two operations.
Acquire a compressed image 10 in which the information regarding the wavelength bands is compressed.
Identify at least one first pixel that is included in the compressed image 10 and that is estimated to be a factor 101 causing reconstruction errors in images reconstructed from the compressed image 10, on the basis of the pixel values of the pixels included in the compressed image 10.

Identifying the at least one first pixel includes the following two operations.
Compare the predetermined upper and lower limits for pixel values with the pixel value of each of the pixels included in the compressed image 10.
Identify, as the first pixel(s), pixels whose pixel values exceed the upper limit or fall below the lower limit from among the pixels included in the compressed image 10.

FIG. 11 is a diagram schematically illustrating an example of the display UI 320 for reporting the corresponding pixels in Step S103 illustrated in FIG. 10. In the upper left area of the display UI 320 illustrated in FIG. 11, the compressed image 10 is presented, and the corresponding pixels are highlighted in light gray. In the upper right area of the display UI 320, the frequencies of pixel values are presented, and the predetermined upper and lower limits are represented by dashed lines. In the example illustrated in FIG. 11, the pixel values of some pixels exceed the predetermined upper limit. In the lower area of the display UI 320, a warning pop-up saying “The pixel values of some pixels of the compressed image are saturated. There is a possibility that the accurate spectral information regarding the reconstructed image is not obtained.” is presented. Furthermore, in the warning pop-up, options “adjust exposure time automatically”, “adjust illuminance of illumination”, and “ignore pixel value saturation and perform reconstruction operation” are represented. The user may select the next operation to be performed from among these options through the display UI 320. Note that the warning pop-up is not always necessary.

### (b) Pixels Corresponding to Reconstruction Error Factors 101 and Surrounding Pixels

As described above, since images are assumed to be smooth in the reconstruction operation, not only the pixels corresponding to the reconstruction error factors 101 in the compressed image 10 but also their surrounding pixels surrounding the pixels may be determined to be pixels corresponding to the reconstruction error factors 101. In this specification, the surrounding pixels are also referred to as “second pixels”. In the range formed by these surrounding pixels, for example, the four pixels directly above, below, to the left, and to the right of each corresponding pixel may be set to a fixed value. This fixed value may be input by the user through the input UI 310 or set automatically by the processing circuit 210. Not only the at least one first pixel above but also the second pixels surrounding the at least one first pixel may be displayed in a highlighted manner.

In a case where the pixel value of a certain pixel exceeds the predetermined upper limit and is saturated, the reconstruction error basically propagates from the pixel to about four pixels. However, this may vary depending on the target and the image capturing conditions. For example, in a case where the pixel values of some pixels exceed the predetermined upper limit and their surrounding pixels fall below the predetermined lower limit, the reconstruction errors will propagate from each of these pixels to four or more pixels. A fixed value for the above surrounding pixels is set with this effect taken into consideration.

(c) Pixels Connected Across Certain Range by being Adjacent Among Pixels Corresponding to Reconstruction Error Factors 101

As described above, since images are assumed to be smooth, there may be a case where the pixels whose pixel values are saturated are complemented in the reconstruction operation if the number of such pixels is small. For example, in a case where pixel values are saturated in a pixel region where 1×1 or 2×2 pixels are connected, there may be a case where saturated pixels are complemented under the assumption that the differences in pixel value between the pixels and their surrounding pixels are smooth. In this case, it may be determined that no pixels correspond to the reconstruction error factors 101. Pixel regions that can be complemented and the threshold for the number of pixels can be set. For typical targets, pixel regions that can be complemented are pixel regions of about four pixels per side. Thus, in a case where there are four or more adjacent pixels, for example, the pixels may be highlighted.

### 2.5.2. About Reconstruction Error Factor (B)

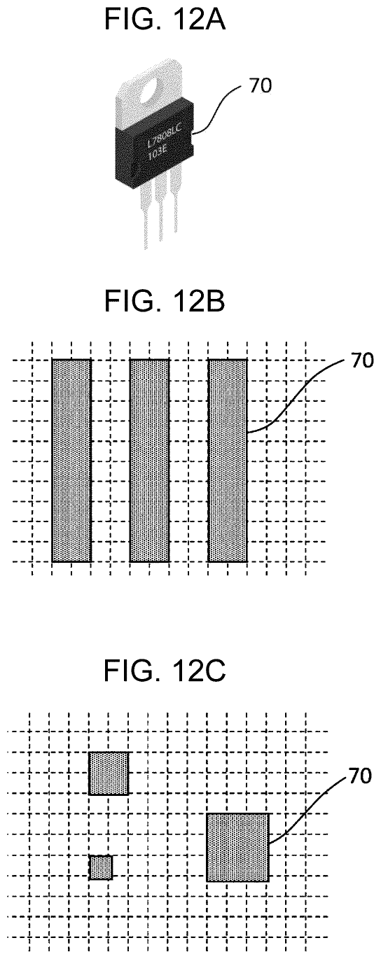

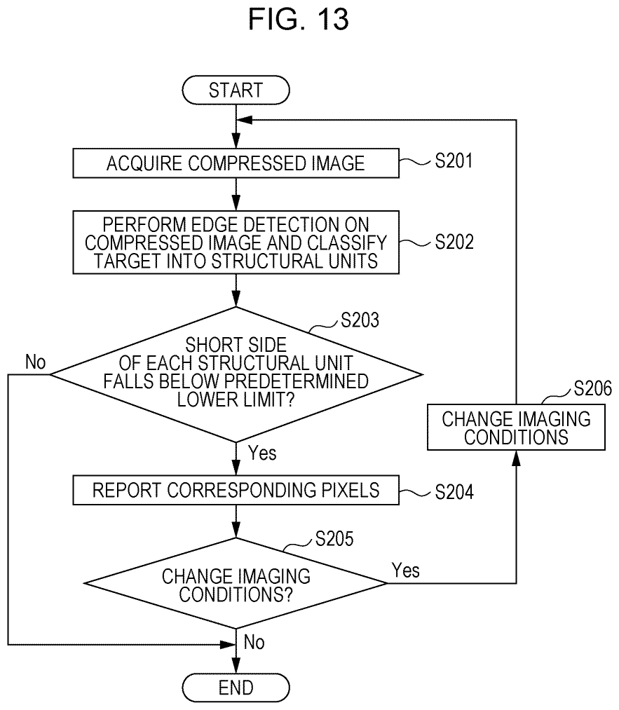

Next, with reference to FIGS. 12A to 13, an example of the reconstruction accuracy estimation operation for the reconstruction error factor (B) will be described. The method for reporting pixels corresponding to the reconstruction error factors 101 is substantially the same as the methods for the above (a) to (c).

FIG. 12A is a diagram schematically illustrating an electronic component as an example of the target 70. The electronic component, which is the target 70, illustrated in FIG. 12A has a black rectangular parallelepiped portion, a plate-like portion with a hole located above the rectangular parallelepiped portion, three pins located below the rectangular parallelepiped portion, and a print on the rectangular parallelepiped portion. The electronic component is classified into these four structural units. For example, the structural units can be the smallest units defined by the edges between two colors. The shorter the short side, which is the shortest side of the structural units of the target 70, is relative to a predetermined lower limit described below, the lower the reconstruction accuracy becomes. In this case, the “short side” refers to the shortest side of the structure, such as the thinness of a hair in the case of hair or the width of a line in the case of text; however, for example, the “short side” may also refer to one side of a rectangle into which the structure is fitted.

FIGS. 12B and 12C are diagrams schematically illustrating elongated components and square-shaped components, respectively, as examples of the target 70. The regions defined by the dashed lines in the grid pattern illustrated in FIGS. 12B and 12C represent pixels included in the compressed image 10. In a case where elongated structures are disposed side by side as illustrated in FIG. 12B and a case where each side of each of the square-shaped structures is short as illustrated in FIG. 12C, the reconstruction accuracy decreases.

FIG. 13 is a flowchart schematically illustrating an example of the reconstruction accuracy estimation operation performed for the reconstruction error factor (B) by the processing circuit 210 according to the present embodiment. The processing circuit 210 performs the operations in Steps S201 to S206 illustrated in FIG. 13.

### Step S201

The processing circuit 210 causes the imaging device 100 to capture a compressed image 10 of the target 70 and acquires the compressed image 10. The user may input imaging conditions of the imaging device 100 through the input UI 310 before acquiring the compressed image. The imaging conditions may include, for example, the zoom magnification of the imaging device 100.

### Step S202

The processing circuit 210 performs edge detection on the compressed image and classifies the target 70 into structural units. For example, the Canny method may be used for edge detection.

### Step S203

The processing circuit 210 finds the short side of each structural unit and determines whether or not the short side falls below a predetermined lower limit. In other words, the processing circuit 210 determines whether or not the compressed image 10 includes pixels corresponding to the structural unit of the target 70 whose short side falls below the predetermined lower limit. The predetermined lower limit may be set in advance by the user through the input UI 310 or set automatically by the processing circuit 210. In a case where high reconstruction accuracy is desired, the predetermined lower limit may be, for example, a length of greater than or equal to four pixels and less than or equal to ten pixels. In a case where it is sufficient that the target 70 be visible in the compressed image 10, the predetermined lower limit may be, for example, a length of greater than or equal to two pixels and less than or equal to four pixels. The predetermined lower limit may be a length of one pixel. In a case where a determination of Yes is obtained, namely, where pixels corresponding to the structural unit whose short side falls below the predetermined lower limit are identified, the processing circuit 210 performs the operation in Step S204. In a case where a determination of No is obtained, namely, where pixels corresponding to the structural unit whose short side falls below the predetermined lower limit are not identified, the processing circuit 210 terminates the processing operation for estimating reconstruction accuracy.

In this specification, about the reconstruction error factor (B), “a reconstruction error is estimated” refers to a case where one or more pixels identified on the basis of the size of the structure of the target 70 as in the above example are determined to be included in the compressed image 10. “A reconstruction error is not estimated” refers to a case where one or more pixels identified on the basis of the size of the structure of the target 70 as in the above example are determined not to be included in the compressed image 10.

### Step S204

The processing circuit 210 notifies the user of the corresponding pixels in the compressed image 10 through the display UI 320. The number of corresponding pixels is one or more.

### Step S205

The processing circuit 210 determines whether or not to change the imaging conditions. In a case where the target 70 is not suitable as an imaging target, a case where the imaging conditions for the imaging device 100 are not properly adjusted, or both cases, the processing circuit 210 changes the imaging conditions. In a case where the imaging conditions are to be changed, the processing circuit 210 may provide an output recommending the user to change at least one of the target 70 included in the compressed image 10 or the image capturing region of the imaging device 100, which acquires the compressed image 10, through the display UI 320, for example. In a case where the corresponding pixels are not connected across a certain range in Step S204, the reconstruction errors do not propagate to the surrounding pixels, so that the imaging conditions need not be changed. In order to make it possible for the user to make a determination, the processing circuit 210 may receive an input from the user through the input UI 310 to determine whether or not to change the imaging conditions. In a case where a determination of Yes is obtained, the processing circuit 210 performs the operation in Step S206. In a case where a determination of No is obtained, the processing circuit 210 terminates the processing operation for estimating reconstruction accuracy.

### Step S206

The processing circuit 210 changes the imaging conditions. In that case, the processing circuit 210 may output a signal to change the zoom magnification of the imaging device 100, which acquires the compressed image 10, for example. The processing circuit 210 performs the operation in Step S201 again after the operation in Step S206.

As described above, the information processing method performed using a computer according to the present embodiment includes the following two operations.
Acquire a compressed image 10 in which the information regarding the wavelength bands is compressed.
Identify at least one first pixel that is included in the compressed image 10 and that is estimated to cause reconstruction errors in images reconstructed from the compressed image 10, on the basis of the size of the structure of the target 70 represented by the compressed image 10.

Identifying the first pixel(s) includes the following three operations.
Detect the edges included in the compressed image 10.
Compare the size of the outline of the structure represented by the detected edges with a predetermined lower limit for the size of the outline.
Identify the pixel(s) of the compressed image 10 corresponding to the structure as the first pixel(s) in a case where the size of the outline falls below the predetermined lower limit.

The size of the outline of the structure may be, for example, the length of the short side of the above structural unit.

### 2.5.3. About Reconstruction Error Factor (C)

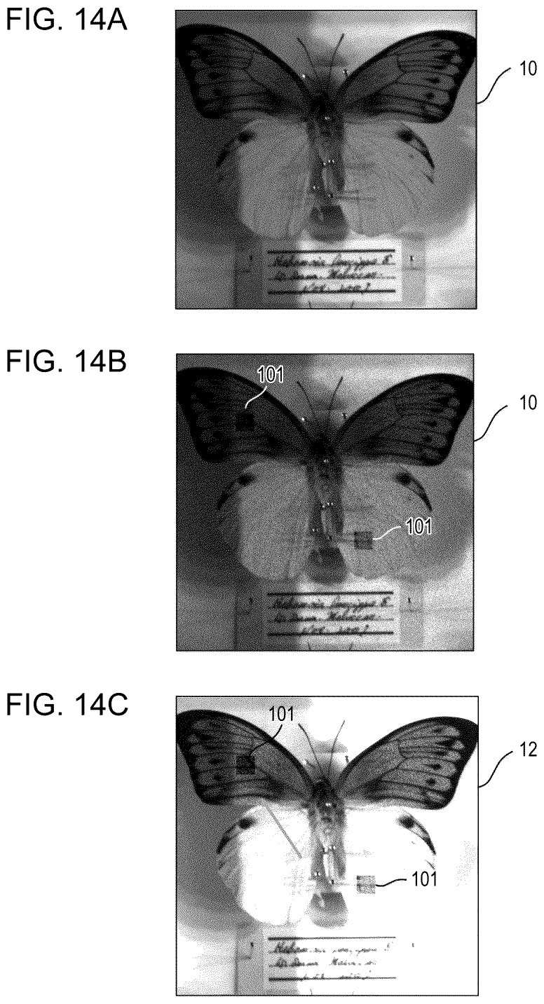

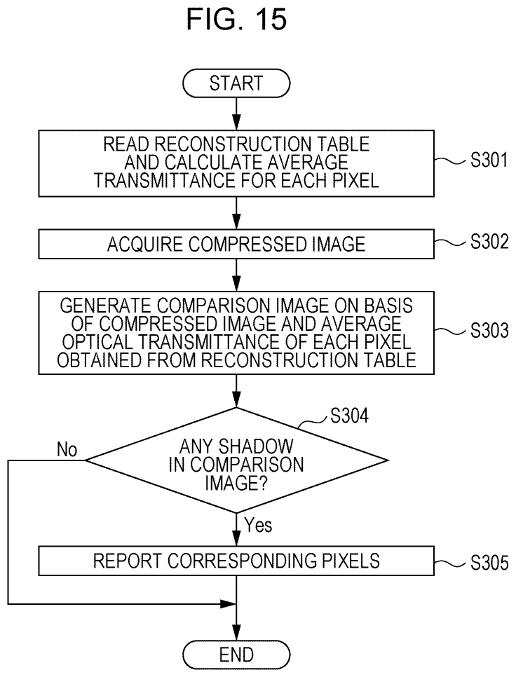

Next, with reference to FIGS. 14A to 15, an example of the reconstruction accuracy estimation operation for the reconstruction error factor (C) will be described. The method for reporting pixels corresponding to the reconstruction error factors 101 is substantially the same as the methods for the above (a) to (c).

Reconstruction errors may occur in the hyperspectral image 20 due to the aging of the imaging device 100 from the time of shipment. In the imaging device 100 using compressed sensing technology, reconstructed images 20W₁, 20W₂, . . . , 20W_{N} are generated from a compressed image by performing the reconstruction operation using the encoding information of the filter array 110 at the time of shipment. Thus, if it is possible to evaluate the consistency between the encoding information of the filter array 110 used to acquire the compressed image 10 and the encoding information of the filter array 110 obtained at the time of shipment, the reconstruction errors in the hyperspectral image 20 can be estimated without performing the reconstruction operation. In this case, the “consistency” means that the difference between the encoding information of the filter array 110 used to acquire the compressed image 10 and the encoding information of the filter array 110 obtained at the time of shipment is negligibly small.

FIGS. 14A to 14C are diagrams for describing the method for determining whether or not foreign matter has adhered to the filter array 110. The compressed images 10 illustrated in FIGS. 14A to 14C represent a butterfly as a target. The compressed image 10 illustrated in FIG. 14A is an image acquired through the filter array 110 without any adhered foreign matter. The compressed image 10 illustrated in FIG. 14B is an image acquired through the filter array 110 with adhered foreign matter. The compressed image 10 illustrated in FIG. 14B includes reconstruction error factors 101 caused by foreign matter. In the compressed image 10, the reconstruction error factors 101 appear as shadows. Note that these shadows may be caused by the state of the butterfly, and thus it is not easy to uniquely determine whether or not foreign matter has adhered to the filter array 110.

Whether or not foreign matter has adhered to the filter array 110 can be determined using the encoding information of the filter array 110 obtained at the time of shipment. The reconstruction table including the encoding information of the filter array 110 obtained at the time of shipment is stored in the storage device 220 illustrated in FIG. 9. For example, the reconstruction table may have, for each of the wavelength bands included in the target wavelength range, data of the optical transmittance of each of the two-dimensionally arranged filters. In this case, the filters in the filter array 110 correspond one-to-one to the pixels in the compressed image 10.

As an example only, the elements of the two-dimensional matrix included in the reconstruction table and obtained by averaging the optical transmittance of each of the filters across all wavelength bands represent the average optical transmittance of each filter in the filter array 110. Since the filters correspond one-to-one to the pixels, “each filter” may be read as “each pixel”. On the basis of the results of comparing the elements of the two-dimensional matrix with the compressed image 10, it becomes possible to determine whether or not foreign matter has adhered to the filter array 110.

A comparison image 12 illustrated in FIG. 14C is an image obtained through the following operations. That is, the operation of dividing the pixel value of each pixel included in the compressed image 10 illustrated in FIG. 14B by the corresponding average optical transmittance obtained from the reconstruction table is performed for all pixels. The comparison image 12 illustrated in FIG. 14C corresponds to a monochrome image of the butterfly. In a case where the encoding information of the filter array 110 obtained at the time when the compressed image 10 was acquired is inconsistent with the encoding information of the filter array 110 obtained at the time of shipment, the differences between the pixel values of the pixels corresponding to the filters with adhered foreign matter in the filter array 110 and the pixel values of their surrounding pixels are large. As a result, in the comparison image 12 illustrated in FIG. 14C, the shadows that are created in the pixels corresponding to the reconstruction error factors 101 become clearer. In contrast, in a case where the above two pieces of encoding information are consistent, such a shadow is not created. In this case, the example has been described in which foreign matter has adhered to the filter array 110; however, the same applies to cases in which foreign matter adheres to the light reception surface of the image sensor 160 included in the imaging device 100, the surface of the optical system 140, or both.

As described above, in a case where the pixels corresponding to the reconstruction error factors 101 are identified in the compressed image 10 using the encoding information of the filter array 110 obtained at the time of shipment, it can be estimated that an abnormality has occurred in the imaging device 100 including the filter array 110. In such cases, the user is notified of an abnormality and a maintenance recommendation for the imaging device 100 via the display UI 320.

FIG. 15 is a flowchart schematically illustrating an example of a reconstruction accuracy estimation operation performed for the reconstruction error factor (C) by the processing circuit 210 according to the present embodiment. The processing circuit 210 performs the operations in Steps S301 to S305 illustrated in FIG. 15.

### Step S301

The processing circuit 210 reads the reconstruction table from the storage device 220 and calculates, for all wavelength bands, the average transmittance for each pixel.

### Step S302

The processing circuit 210 causes the imaging device 100 to capture a compressed image 10 of the target 70 and acquires the compressed image 10.

### Step S303

The processing circuit 210 generates a comparison image 12 on the basis of the compressed image 10 and the average optical transmittance of each pixel obtained from the reconstruction table.

### Step S304

The processing circuit 210 determines whether or not there is a shadow in the comparison image 12. In other words, the processing circuit 210 determines whether or not a pixel corresponding to a shadow in the comparison image 12 is included in the compressed image 10. In a case where a determination of Yes is obtained, namely, where a pixel corresponding to a shadow is identified, the processing circuit 210 performs the operation in Step S305. In a case where a determination of No is obtained, namely, where a pixel corresponding to a shadow is not identified, the processing circuit 210 terminates the processing operation for estimating reconstruction accuracy.

In this specification, about the reconstruction error factor (C), “a reconstruction error is estimated” refers to a case where one or more pixels identified on the basis of the encoding information in addition to the pixel values as in the above example are determined to be included in the compressed image 10. “A reconstruction error is not estimated” refers to a case where one or more pixels identified on the basis of the encoding information in addition to the pixel values as in the above example are determined not to be included in the compressed image 10.

### Step S305

The processing circuit 210 notifies the user of the corresponding pixels in the compressed image 10 through the display UI 320. The number of corresponding pixels is one or more. During the notification, the processing circuit 210 provides at least one of an output indicating that the optical system included in the imaging device 100 that has acquired the compressed image 10 has an abnormality or an output recommending the user to perform maintenance of the imaging device 100. The display UI 320 may display a pop-up, such as “There may be foreign matter on the lens. Please clean the lens”. If the situation remains unchanged, a pop-up, such as “There may be an abnormality inside the imaging device. Please send the imaging device back to the manufacturer” may be displayed.

As described above, the information processing method performed using a computer according to the present embodiment includes the following two operations.
Acquire a compressed image 10 in which the information regarding the wavelength bands is compressed.
Identify, on the basis of the encoding information used to reconstruct images corresponding to the respective wavelength bands from the compressed image 10 in addition to the pixels values of the pixels included in the compressed image 10, at least one first pixel included in the compressed image 10 that is estimated to cause reconstruction errors in the images reconstructed from the compressed image 10.

The encoding information includes matrix elements corresponding to the respective wavelength bands. More specifically, the encoding information represents, for each of the wavelength bands, the optical transmittance of each of the filters arranged two-dimensionally in the filter array 110.

Identifying the first pixels includes identifying the first pixels on the basis of the compressed image and elements obtained by averaging, across the wavelength bands, the matrix elements corresponding to the respective wavelength bands.

In this specification, identifying at least one first pixel on the basis of the pixel values of the pixels included in the compressed image 10 includes not only estimating reconstruction accuracy for the reconstruction error factor (A) but also estimating reconstruction accuracy for the reconstruction error factor (C).

Note that in the above example described with reference to FIGS. 10 to 15, the processing circuit 210 estimates reconstruction accuracy for any one of the reconstruction error factors (A) to (C) but is not limited to the above examples. The processing circuit 210 may estimate reconstruction accuracy for two or all of the reconstruction error factors (A) to (C). In other words, the processing circuit 210 estimates reconstruction accuracy for at least one of the reconstruction error factors (A) to (C).

In this specification, “at least one of α, β, or γ” and “at least one of α to γ” refer to only α, only β, only γ, α and β, and γ, α and γ, or all α, β, and γ.

### 2.6. Various Modifications

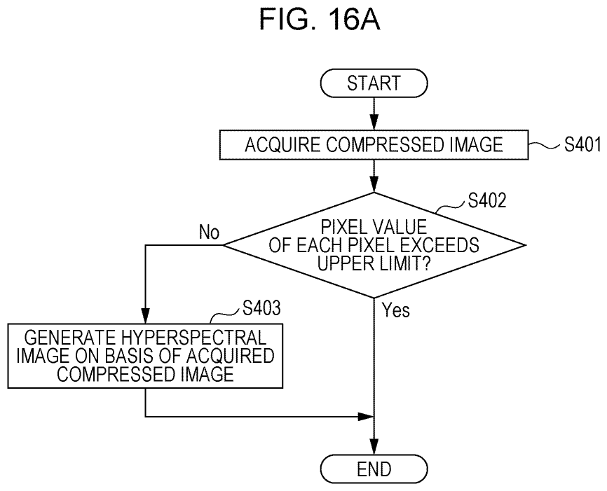

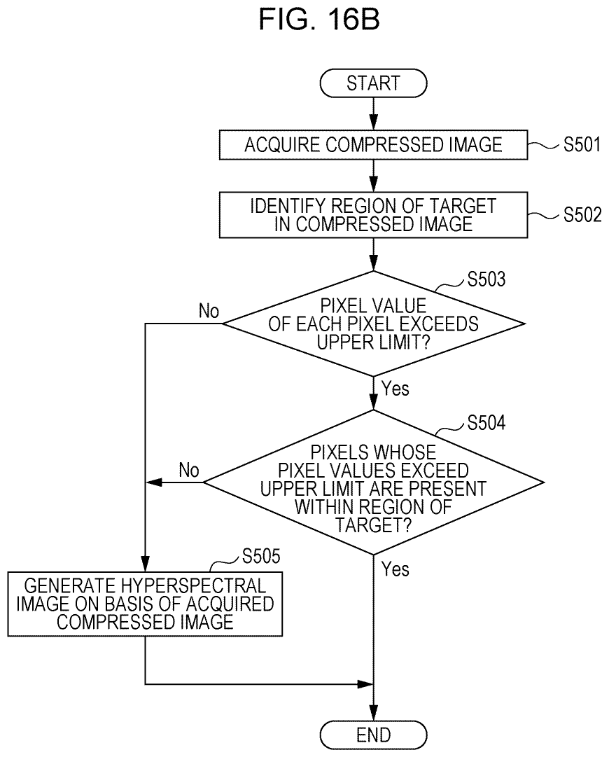

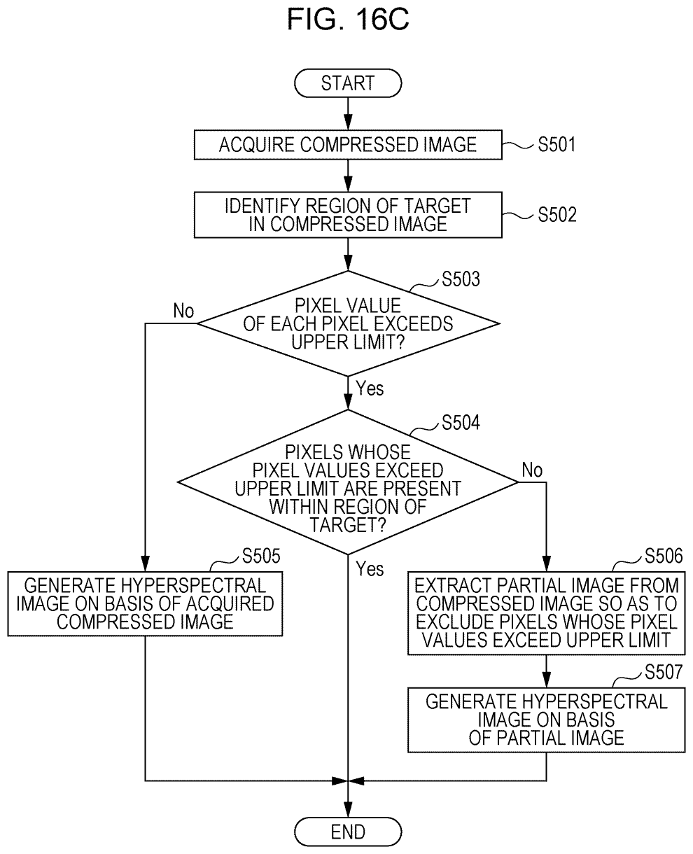

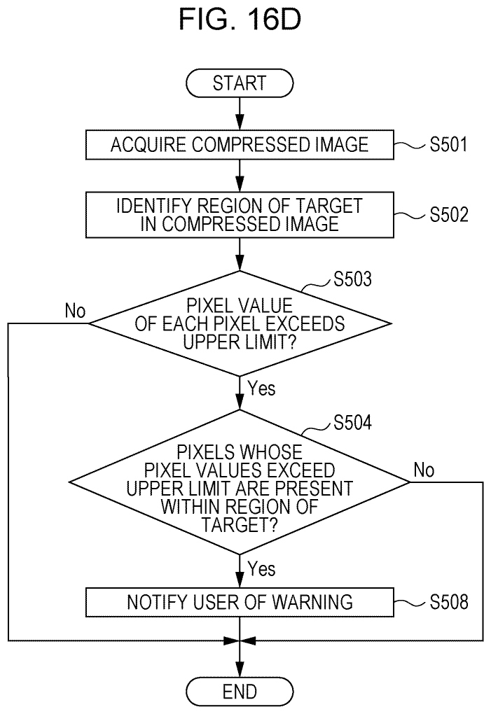

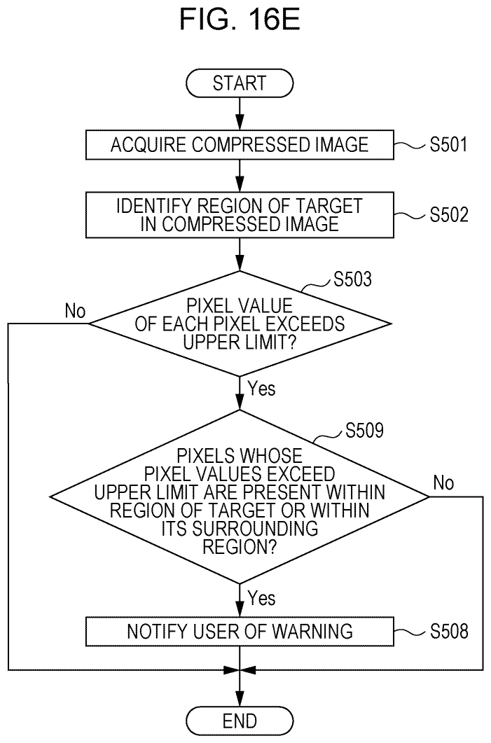

Next, with reference to FIGS. 16A to 16E, Modifications 1 to 5 of the information processing method according to the present embodiment described above will be described. The following will mainly describe the reconstruction error factor (A), but it may be read as applying to the reconstruction error factor (B) or (C) unless a contradiction arises.

### 2.6.1. Modification 1

FIG. 16A is a flowchart schematically illustrating an example of the operation performed by the processing circuit 210 according to Modification 1 of the present embodiment. The processing circuit 210 performs the operations in Steps S401 to S403 illustrated in FIG. 16A.

### Step S401

The processing circuit 210 causes the imaging device 100 to capture a compressed image 10 of the target 70 and acquires the compressed image 10. The operation in Step S401 illustrated in FIG. 16A is the same as that in Step S101 illustrated in FIG. 10.

### Step S402

The processing circuit 210 determines whether or not the pixel value of each of the pixels included in the compressed image 10 exceeds the predetermined upper limit. In a case where a determination of Yes is obtained, namely, where one or more pixels having pixel values greater than the upper limit are identified, the processing circuit 210 terminates the processing operation without generating a hyperspectral image 20. In a case where a determination of No is obtained, namely, where one or more pixels having pixel values greater than the upper limit are not identified, the processing circuit 210 performs the operation in Step S403.

### Step S403

The processing circuit 210 generates a hyperspectral image 20 on the basis of the compressed image acquired in Step S401 and the reconstruction table.

In Modification 1, in a case where a determination of Yes is obtained in Step S402, the processing circuit 210 does not generate a hyperspectral image 20, and in a case where a determination of No is obtained in Step S402, the processing circuit 210 generates a hyperspectral image 20. This switching operation can prevent the generation of a hyperspectral image 20 with low reconstruction accuracy, in a case where the compressed image 10 includes pixels having pixel values that exceed the upper limit.

In Modification 1, the above switching operation is performed for the reconstruction error factor (A) in accordance with the determinations as to whether or not the pixel value of each pixel exceeds the upper limit, but is not limited to this example. The above switching operation may be performed for the reconstruction error factor (B) in accordance with the determinations as to whether or not the short sides of the structural units of the target 70 fall below the lower limit. Alternatively, the above switching operation may be performed for the reconstruction error factor (C) in accordance with the determination performed by the processing circuit 210 as to whether or not there is a shadow in the comparison image 12.

That is, the processing circuit 210 may perform the operations in Steps S201 to S203 illustrated in FIG. 13 or the operations in Steps S301 to S304 illustrated in FIG. 15, instead of the operations in Steps S401 and S402 illustrated in FIG. 16A.

### 2.6.2. Modification 2

FIG. 16B is a flowchart schematically illustrating an example of the operation performed by the processing circuit 210 according to Modification 2 of the present embodiment. The processing circuit 210 performs the operations in Steps S501 to S505 illustrated in FIG. 16B.

### Step S501

The operation in Step S501 is the same as the operation in Step S101 illustrated in FIG. 10.

### Step S502

The processing circuit 210 identifies the region of the target 70 in the compressed image 10. For example, the following three methods may be used as the method for identifying the region of the target 70.
The user specifies the region of the target 70 in the compressed image 10 through the input UI 310 using a pointing device, examples of which include a mouse and a touch panel.
Extract the region of the target 70 from the compressed image 10 using edge detection.
Identify the region of the target 70 in the compressed image 10 using a model that receives the compressed image 10 as an input and outputs the recognition result of the target 70 in the compressed image 10.

The model is generated through the learning of various targets using machine learning algorithms. Machine learning can use, for example, deep learning, support vector machines, decision trees, genetic programming, or Bayesian network algorithms. In a case where deep learning is used, for example, algorithms such as convolutional neural networks (CNN) or recurrent neural networks (RNN) may be used.

### Step S503

The operation in Step S503 is the same as the operation in Step S402 illustrated in FIG. 16A. In a case where a determination of Yes is obtained, the operation in Step S504 is performed. In a case where a determination of No is obtained, the processing circuit 210 performs the operation in Step S505.

### Step S504

The processing circuit 210 determines whether or not one or more pixels whose pixel values exceed the upper limit are present within the region of the target 70. In a case where a determination of Yes is obtained, namely, where one or more such pixels are present within the region of the target 70, the processing circuit 210 terminates the processing operation without generating a hyperspectral image 20. In a case where a determination of No is obtained, namely, where one or more such pixels are present outside the region of the target 70, the processing circuit 210 performs the operation in Step S505.

### Step S505

The operation in Step S505 is the same as the operation in Step S403 illustrated in FIG. 16A.

In Modification 2, in a case where a determination of Yes is obtained in Step S503 and where a determination of Yes is obtained in Step S504, the processing circuit 210 does not generate a hyperspectral image 20. In a case where a determination of No is obtained in Step S503 or S504, the processing circuit 210 generates a hyperspectral image 20. This switching operation can prevent the generation of a hyperspectral image 20 in which the reconstruction accuracy of the target 70 is low, in a case where the region of the target 70 within the compressed image 10 has pixels having pixel values that exceed the upper limit.

In Modification 2, the above switching operation is performed for the reconstruction error factor (A) in accordance with the determinations as to whether or not the pixel value of each pixel exceeds the upper limit, but is not limited to this example. The above switching operation may be performed for the reconstruction error factor (B) in accordance with the determinations as to whether or not the short sides of the structural units of the target 70 fall below the lower limit. Alternatively, the above switching operation may be performed for the reconstruction error factor (C) in accordance with the determination as to whether or not there is a shadow in the comparison image 12.

That is, the processing circuit 210 may perform the operations in Steps S201 and S202 illustrated in FIG. 13, instead of the operation in Step S501 illustrated in FIG. 16B. The processing circuit 210 may further perform the operation in Step S203 illustrated in FIG. 13, instead of the operation in Step S503 illustrated in FIG. 16B. In a case where a determination of Yes is obtained in Step S203, the operation corresponding to Step S504 illustrated in FIG. 16B can be omitted because the structural unit whose short side falls below the lower limit is always in the region of the target 70.

Alternatively, the processing circuit 210 may perform the operations in Steps S301 to S303 illustrated in FIG. 15, instead of the operation in Step S501 illustrated in FIG. 16B. The processing circuit 210 may further perform the operation in Step S304 illustrated in FIG. 15, instead of the operation in Step S503 illustrated in FIG. 16B. The processing circuit 210 may further determine whether or not a shadow is present in the region of the target 70, instead of the operation in Step S504 illustrated in FIG. 16B.

### 2.6.3. Modification 3

FIG. 16C is a flowchart schematically illustrating an example of the operation performed by the processing circuit 210 according to Modification 3 of the present embodiment. The processing circuit 210 performs the operations in Steps S501 to S507 illustrated in FIG. 16C. In the following, the differences between Modification 3 and Modification 2 will be described. In Step S504, in a case where a determination of No is obtained, the processing circuit 210 does not perform the operation in Step S505 but performs the operation in Step S506.

### Step S506

The processing circuit 210 extracts a partial image from the compressed image 10 so as to exclude pixels whose pixel values exceed the upper limit. The partial image may be configured to exclude only such pixels. Alternatively, the partial image may be configured to exclude any region other than the region of the target 70.

### Step S507

The processing circuit 210 generates a hyperspectral image 20 on the basis of the partial image extracted from the compressed image 10 and the edited reconstruction table. The edited reconstruction table has, for each of all wavelength bands included in the target wavelength range, the optical transmittance data of each of the pixels corresponding to the partial image. A method for generating a hyperspectral image 20 from a partial image is disclosed, for example, in International Publication No. 2021/246192.

In Modification 3, in a case where a determination of Yes is obtained in Step S503 and where a determination of Yes is obtained in Step S504, the processing circuit 210 does not generate a hyperspectral image 20. In a case where a determination of No is obtained in Step S503, the processing circuit 210 generates a hyperspectral image 20 on the basis of the compressed image 10 and the reconstruction table. In a case where a determination of No is obtained in Step S504, the processing circuit 210 generates a hyperspectral image 20 on the basis of the partial image and the edited reconstruction table. This switching operation makes it possible to generate a hyperspectral image 20 in which the reconstruction accuracy of the target 70 is high.

### 2.6.4. Modification 4

FIG. 16D is a flowchart schematically illustrating an example of the operation performed by the processing circuit 210 according to Modification 4 of the present embodiment. Modification 4 differs from Modification 3 in that in a case where a determination of Yes is obtained in Step S504, the processing circuit 210 performs the operation in Step S508.

### Step S508

The processing circuit 210 outputs a warning notification to the user via the display UI 320. The warning includes a message that an accurate reconstructed image cannot be generated from the current compressed image 10, as illustrated in FIG. 11.

The processing circuit 210 may output, as described above, a signal to change the imaging conditions or display the pixels whose pixel values exceed the predetermined upper limit in a highlighted manner, instead of outputting a warning notification to the user. Alternatively, the processing circuit 210 may perform two or all of the following: outputting a warning notification to the user, outputting a signal to change the imaging conditions, and displaying the pixels whose pixel values exceed the predetermined upper limit in a highlighted manner. That is, the processing circuit 210 performs at least one of outputting a warning notification to the user, outputting a signal to change the imaging conditions, or displaying the pixels in a highlighted manner.

Note that in a case where a determination of No is obtained in Step S503 or S504, the processing circuit 210 does not perform any of the following: outputting a warning notification to the user, outputting a signal to change the imaging conditions, and displaying the pixels in a highlighted manner.

The above warning operation can prevent the generation of a hyperspectral image 20 in which the reconstruction accuracy of the target 70 is low, in a case where the region of the target 70 within the compressed image 10 has pixels having pixel values that exceed the upper limit.

In Modification 4, regarding the reconstruction error factor (A), in a case where the pixel value(s) of one or more pixels included in the compressed image 10 exceed the upper limit and where the pixels are present within the region of the target 70 in the compressed image 10, the user is notified of the warning, but this is not the only example. Regarding the reconstruction error factor (C), in a case where there is a shadow in the comparison image 12 and where the shadow is within the region of the target 70 in the compressed image 10, the user may be notified of the warning.

### 2.6.5. Modification 5

FIG. 16E is a flowchart schematically illustrating an example of the operation performed by the processing circuit 210 according to Modification 5 of the present embodiment. Modification 5 differs from Modification 4 in that the processing circuit 210 performs the operation in Step S509, instead of the operation in Step S504.

### Step S509

The processing circuit 210 determines whether or not one or more pixels whose pixel values exceed the upper limit are present within the region of the target 70 or within the surrounding region of the target 70 in the compressed image 10. In a case where a determination of Yes is obtained, the processing circuit 210 performs the operation in Step S508. In a case where a determination of No is obtained, namely, where one or more such pixels are present outside the region of the target 70 and outside the surrounding region of the target 70 in the compressed image 10, the processing circuit 210 terminates the processing operation without generating a hyperspectral image 20. In this case, the processing circuit 210 does not perform any of the following: outputting a warning notification to the user, outputting a signal to change the imaging conditions, and displaying the pixels in a highlighted manner.

If pixels whose pixel values exceed the upper limit are absent within the region of the target 70 but are present within the surrounding region of the target 70, when a hyperspectral image 20 is generated on the basis of the compressed image 10 and the reconstruction table, the reconstruction errors caused by such pixels may propagate to the region of the target 70. As a result, the reconstruction accuracy of the region of the target 70 in the hyperspectral image 20 may decrease. Thus, in Modification 5, even in a case where pixels whose pixel values exceed the upper limit are present in the surrounding region of the target 70, the user is notified of the warning.

The surrounding region of the target 70 in the compressed image 10 is as follows. The surrounding region of the target 70 is a region surrounding the target 70. The inner perimeter of the surrounding region of the target 70 matches the outer perimeter of the region of the target 70. The outer perimeter of the surrounding region of the target 70 is separated from the inner perimeter of the surrounding region of the target 70 by a predetermined number of pixels at a minimum distance. The predetermined number of pixels may be, for example, greater than or equal to 4 pixels and less than or equal to 250 pixels. The reason why the lower limit corresponds to 4 pixels is that, as described above, the range over which such a reconstruction error propagates is about 4 pixels or is greater than or equal to 4 pixels. The reason why the upper limit corresponds to 250 pixels is to provide enough margin so that such a reconstruction error does not propagate to the region of the target 70. In actual operation, the predetermined number of pixels may be set to 200 pixels, for example.

The above warning operation can prevent the generation of a hyperspectral image 20 in which the reconstruction accuracy of the target 70 is low, in a case where the region or its surrounding region of the target 70 within the compressed image 10 has pixels whose pixel values exceed the upper limit.

In Modification 5, regarding the reconstruction error factor (A), in a case where the pixel value(s) of one or more pixels included in the compressed image 10 exceed the upper limit and where the one or more pixels are present within the region of the target 70 or the surrounding region of the target 70 in the compressed image 10, the user is notified of the warning; however, this is not the only example. Regarding the reconstruction error factor (C), in a case where there is a shadow in the comparison image 12 and where the shadow is within the region of the target 70 or the surrounding region of the target 70 in the compressed image 10, the user may be notified of the warning.

Note that the operations in Modifications 1 to 5 can be combined as desired. In Modification 1, in a case where a determination of Yes is obtained in Step S402 illustrated in FIG. 16A, the processing circuit 210 terminates the processing operation; however, what is performed is not limited to this example. In a case where a determination of Yes is obtained in Step S402, the processing circuit 210 may perform the operation in Step S508 illustrated in FIG. 16D.

Similarly, in Modifications 2 and 3, in a case where a determination of Yes is obtained in Step S504 illustrated in FIGS. 16B and 16C, the processing circuit 210 terminates the processing operation; however, what is performed is not limited to this example. In a case where a determination of Yes is obtained in Step S504, the processing circuit 210 may perform the operation in Step S508 illustrated in FIG. 16D.

In Modifications 2 and 3, the processing circuit 210 performs the operation in Step S504 illustrated in FIGS. 16B and 16C; however, what is performed is not limited to these examples. The processing circuit 210 may perform Step S509 illustrated in FIG. 16E, instead of Step S504.

In Modification 5, in a case where a determination of No is obtained in Step S503 or S509 illustrated in FIG. 16E, the processing circuit 210 terminates the processing operation; however, what is performed is not limited to this example. In a case where a determination of No is obtained in Step S503 or S509 illustrated in FIG. 16E, the processing circuit 210 may perform Step S505 illustrated in FIGS. 16B and 16C. Alternatively, in a case where a determination of No is obtained in Step S503, the processing circuit 210 may perform Step S505 illustrated in FIGS. 16B and 16C, and in a case where a determination of No is obtained in Step S509, the processing circuit 210 may perform Steps S506 and S507 illustrated in FIG. 16C.

2.7. Application Example of Information Processing Method according to Present Embodiment

The information processing method according to the present embodiment can be used, for example, to inspect products carried by a conveyor belt. Before generating a hyperspectral image 20 of a product carried by a conveyor belt, the processing circuit 210 acquires a compressed image 10 of the product using the imaging device 100 and determines whether or not the compressed image 10 has the reconstruction error factors (A) to (C). In a case where the compressed image 10 has the reconstruction error factor (A), if the pixels corresponding to the reconstruction error factor (A) in the compressed image 10 are displayed in a highlighted manner via the display UI 320, this is easier for the user to understand. The processing circuit 210 changes the imaging conditions so as to meet the reconstruction accuracy, the analysis accuracy, or both desired by the user. An example of analysis is the inspection of the product's appearance, including its coloring. Thereafter, the processing circuit 210 regenerates a hyperspectral image 20 from the reacquired compressed image 10. The above determination may be performed before the reconstruction operation for generating a hyperspectral image 20 or in parallel with the reconstruction operation. Furthermore, the above determination may be performed at the discretion of the user or automatically by the imaging system.

### 3. Appendix

The above description of the embodiments discloses the following techniques.

### Technique 1

A method, which is an information processing method performed using a computer, including:
acquiring a compressed image, in which information regarding wavelength bands is compressed, and
identifying, based on at least one of
(1) pixel values of pixels included in the compressed image, or
(2) a size of a structure of a target represented by the compressed image, at least one first pixel that is included in the compressed image and that is estimated to cause a reconstruction error in images corresponding to the respective wavelength bands, the images being reconstructed from the compressed image.

This method allows estimating, at a relatively low computational cost, reconstruction accuracy in a case where reconstructed images are generated from an image in which spectral information is compressed.

### Technique 2

The method described in Technique 1, in which in a case of (1),
the identifying includes identifying at least one first pixel, based on (3) encoding
information used to reconstruct the images from the compressed image, in addition to the pixel values of the pixels included in the compressed.

This method allows estimating, at a relatively low computational cost, reconstruction accuracy in a case where reconstructed images are generated from an image in which spectral information is compressed.

### Technique 3

The method described in Technique 1 or 2, further including:
in a case where the at least one first pixel includes adjacent pixels, displaying the at least one first pixel in a highlighted manner.

This method makes it easier for the user to recognize pixels corresponding to a reconstruction error factor.

### Technique 4

The method described in any one of Techniques 1 to 3, further including:
in a case where adjacent pixels included in the at least one first pixel include four or more pixels, displaying the at least one first pixel in a highlighted manner.

This method makes it easier for the user to recognize pixels that correspond to a reconstruction error factor and are not complemented in the reconstruction operation.

### Technique 5

The method described in any one of Techniques 1 to 4, further including:
displaying second pixels surrounding the at least one first pixel, in a highlighted manner.

This method makes it easier for the user to recognize not only pixels corresponding to a reconstruction error factor, but also the surrounding pixels where the reconstruction error propagates.

### Technique 6

The method described in any one of Techniques 1 to 5, in which
the identifying at least one first pixel based on (1) the pixel values of the pixels included in the compressed image includes
comparing predetermined upper and lower limits for pixel values with the pixel value of each of pixels included in the compressed image, and
identifying, from among the pixels included in the compressed image, a pixel whose pixel value exceeds the predetermined upper limit or falls below the predetermined lower limit as the at least one first pixel.

This method allows the first pixel(s) to be identified on the basis of the predetermined upper and lower limits for pixel values.

### Technique 7

The method described in any one of Techniques 1 to 6, further including:
in a case where a reconstruction error is estimated based on (1) the pixel values of the pixels included in the compressed image, providing an output recommending a user to adjust at least one of exposure time of an imaging device that has acquired the compressed image or illumination in an image capturing environment for acquiring the compressed image.

This method allows the user to change the imaging conditions and reduce the possibility of occurrence of the reconstruction error in the reconstructed image.

### Technique 8

The method described in any one of Techniques 1 to 7, further including:
in a case where a reconstruction error is estimated based on (1) the pixel values of the pixels included in the compressed image, outputting a signal to change at least one of exposure time of an imaging device that has acquired the compressed image or illumination output in an image capturing environment for acquiring the compressed image.

This method allows the imaging conditions to be changed.

### Technique 9

The method described in any one of Techniques 1 to 5, in which
the identifying at least one first pixel based on (2) the size of the structure represented by the compressed image includes
detecting an edge included in the compressed image,
comparing a size of an outline of the structure represented by the detected edge with a predetermined lower limit for the size of the outline, and
identifying, in a case where the size of the outline falls below the predetermined lower limit, the pixels of the compressed image corresponding to the structure as the at least one first pixel.

This method allows the first pixel(s) to be identified based on the predetermined lower limit for the size of the outline.

### Technique 10

The method described in any one of Techniques 1 to 5 and 9, further including:
providing, in a case where a reconstruction error is estimated based on (2) the size of the structure represented by the compressed image, an output recommending a user to change at least one of the target included in the compressed image or an image capturing region of the imaging device that acquires the compressed image.

This method allows the user to change the imaging conditions and reduce the possibility of occurrence of the reconstruction error in the reconstructed image.

### Technique 11

The method described in any one of Techniques 1 to 5, 9, and 10, further including:
outputting, in a case where a reconstruction error is estimated based on (2) the size of the structure represented by the compressed image, a signal to change a zoom magnification of the imaging device that acquires the compressed image.

This method allows the imaging conditions to be changed.

### Technique 12

The method described in Technique 2 and any one of Techniques 3 to 5 that directly or indirectly reference Technique 2, in which
the encoding information includes matrix elements corresponding to the respective wavelength bands, and
the identifying at least one first pixel based on (3) the encoding information in addition to the pixel values of the pixels included in the compressed image includes identifying at least one first pixel, based on the compressed image and elements obtained by averaging, across the wavelength bands, the matrix elements corresponding to the respective wavelength bands.

This method allows the first pixel(s) to be identified on the basis of the above elements and the compressed image.

### Technique 13

The method described in Technique 2 and any one of Techniques 3 to 5 and 12 that directly or indirectly reference Technique 2, further including:
providing, in a case where a reconstruction error is estimated based on (3) the encoding information in addition to the pixel values of the pixels included in the compressed image, at least one of an output indicating that an optical system included in the imaging device that has acquired the compressed image has an abnormality or an output recommending a user to perform maintenance of the imaging device.

This method allows the user to recognize that the optical system of the imaging device has an abnormality and that maintenance should be performed on the imaging device.

### Technique 14

The method described in Technique 1 or 2, further including:
reconstructing the images from the compressed image in a case where a reconstruction error is not estimated based on at least one of (1) the pixel values of the pixels included in the compressed image or (2) the size of the structure represented by the compressed image.

This method can prevent the generation of reconstructed images with low reconstruction accuracy.

### Technique 15

The method described in Technique 1 or 2, further including:
reconstructing the images from the compressed image in a case where the at least one first pixel is present outside a region of the target in the compressed image, and
refraining from reconstructing the images from the compressed image in a case where the at least one first pixel is present within the region of the target in the compressed image.

This method can prevent the generation of reconstructed images with low reconstruction accuracy.

### Technique 16

The method described in Technique 1 or 2, further including:
extracting, in a case where the at least one first pixel is present outside a region of the target in the compressed image, a partial image from the compressed image so as to exclude the at least one first pixel, and reconstructing the images from the extracted partial image.

This method makes it possible to generate reconstructed images in which the reconstruction accuracies of targets are high.

### Technique 17

The method described in Technique 1 or 2, further including:
in a case where the at least one first pixel is present within a region of the target or a surrounding region of the target in the compressed image, performing at least one of outputting a warning notification to a user, outputting a signal to change an imaging condition, or displaying the at least one first pixel in a highlighted manner.

This method can prevent the generation of reconstructed images with low reconstruction accuracy.

### Technique 18

The method described in Technique 17, further including:
in a case where the at least one first pixel is present within the region of the target in the compressed image, performing at least one of outputting the warning notification to the user, outputting the signal to change the imaging condition, or displaying the at least one first pixel in a highlighted manner.

This method can prevent the generation of reconstructed images in which the reconstruction accuracies of targets are low.

### Technique 19

An imaging system including:
an imaging device that has light receiving regions whose optical response characteristics are different from each other, and
a processing circuit, and
the processing circuit
causes the imaging device to capture a compressed image, in which information regarding wavelength bands is compressed, and acquires the compressed image, and
identifies, based on at least one of
(1) pixel values of pixels included in the compressed image, or
(2) a size of a structure of a target represented by the compressed image, at least one first pixel that is included in the compressed image and that is estimated to cause a reconstruction error in images corresponding to the respective wavelength bands, the images being reconstructed from the compressed image.

This structure allows estimating, at a relatively low computational cost, reconstruction accuracy in a case where reconstructed images are generated from an image in which spectral information is compressed.

### Technique 20

The imaging system described in Technique 19, in which
in a case of (1),
the identifying includes identifying at least one first pixel, based on (3) encoding information used to reconstruct the images from the compressed image, in addition to the pixel values of the pixels included in the compressed image.

This structure allows estimating, at a relatively low computational cost, reconstruction accuracy in a case where reconstructed images are generated from an image in which spectral information is compressed.

### Technique 21

A method, which is an information processing method performed using a computer, including:
acquiring a compressed image, in which information regarding wavelength bands is compressed,
estimating whether or not images reconstructed, based on pixel values of pixels included in the compressed image, from the compressed image and corresponding to the respective wavelength bands include a reconstruction error, and
providing, in a case where it is estimated that the images include a reconstruction error, an output recommending a user to adjust at least one of exposure time of an imaging device that has acquired the compressed image or illumination in an image capturing environment for acquiring the compressed image.

This method allows estimating, at a relatively low computational cost, reconstruction accuracy in a case where reconstructed images are generated from an image in which spectral information is compressed. Furthermore, the user can change the imaging condition and reduce the possibility of occurrence of the reconstruction error in a hyperspectral image.

### Technique 22

A method, which is an information processing method performed using a computer, including:
acquiring a compressed image, in which information regarding wavelength bands is compressed,
estimating whether or not images reconstructed, based on pixel values of pixels included in the compressed image, from the compressed image and corresponding to the respective wavelength bands include a reconstruction error, and
outputting, in a case where it is estimated that the images include a reconstruction error, a signal to change at least one of exposure time of an imaging device that has acquired the compressed image or illumination output in an image capturing environment for acquiring the compressed image.

This method allows estimating, at a relatively low computational cost, reconstruction accuracy in a case where reconstructed images are generated from an image in which spectral information is compressed. Furthermore, the imaging condition can be changed.

### Technique 23

A method, which is an information processing method performed using a computer, including:
acquiring a compressed image in which information regarding wavelength bands is compressed,
estimating whether or not images reconstructed, based on a size of a structure of a target represented by the compressed image, from the compressed image and corresponding to the respective wavelength bands include a reconstruction error, and
providing, in a case where it is estimated that the images include a reconstruction error, an output recommending a user to change at least one of the target included in the compressed image or an image capturing region of an imaging device that acquires the compressed image.

This method allows estimating, at a relatively low computational cost, reconstruction accuracy in a case where reconstructed images are generated from an image in which spectral information is compressed. Furthermore, the user can change the imaging condition and reduce the possibility of occurrence of the reconstruction error in a hyperspectral image.

### Technique 24

A method, which is an information processing method performed using a computer, including:
acquiring a compressed image, in which information regarding wavelength bands is compressed,
estimating whether or not images reconstructed, based on a size of a structure of a target represented by the compressed image, from the compressed image and corresponding to the respective wavelength bands include a reconstruction error, and
outputting, in a case where it is estimated that the images include a reconstruction error, a signal to change a zoom magnification of the imaging device that acquires the compressed image.

This method allows estimating, at a relatively low computational cost, reconstruction accuracy in a case where reconstructed images are generated from an image in which spectral information is compressed. Furthermore, the user can change the imaging condition and reduce the possibility of occurrence of the reconstruction error in a hyperspectral image.

### Technique 25

A method, which is an information processing method performed using a computer, including:
acquiring a compressed image, in which information regarding wavelength bands is compressed,
estimating whether or not images corresponding to the respective wavelength bands and reconstructed, based on encoding information in addition to the pixel values of the pixels included in the compressed image, from the compressed image include a reconstruction error, the encoding information being used to reconstruct the images from the compressed image, and
providing, in a case where it is estimated that the images include a reconstruction error, at least one of an output indicating that an optical system included in an imaging device that has acquired the compressed image has an abnormality or an output recommending maintenance of the imaging device.

### Technique 26

A method, which is an information processing method performed using a computer, including:
acquiring a compressed image, in which information regarding wavelength bands is compressed, and
determining whether or not a first pixel is included in the compressed image, the first pixel being estimated to cause a reconstruction error in images corresponding to the respective wavelength bands and reconstructed, based on at least one of
(1) pixel values of pixels included in the compressed image, or
(2) a size of a structure of a target represented by the compressed image, from the compressed image.

This method allows estimating, at a relatively low computational cost, reconstruction accuracy in a case where reconstructed images are generated from an image in which spectral information is compressed.

### Technique 27

The method described in Technique 26, further including:
in a case where it is determined that the first pixel is not included in the compressed image, reconstructing the images from the compressed image.

This method makes it possible to generate reconstructed images in which the reconstruction accuracies of targets are high.

This method allows estimating, at a relatively low computational cost, reconstruction accuracy in a case where reconstructed images are generated from an image in which spectral information is compressed. Furthermore, the user can recognize that the optical system of the imaging device has an abnormality and that maintenance should be performed on the imaging device.

The technology according to the present disclosure is useful, for example, in cameras and measurement devices that acquire multi-wavelength or high-resolution images. The technology according to the present disclosure can be applied, for example, to sensing for biological, medical, and cosmetic applications, inspection systems for foreign matter and pesticide residues in food, remote sensing systems, and in-vehicle sensing systems.

What is claimed is:

1. A method, which is an information processing method performed using a computer, comprising:
acquiring a compressed image, in which information regarding wavelength bands is compressed; and
identifying, based on at least one of
(1) pixel values of pixels included in the compressed image, or
(2) a size of a structure of a target represented by the compressed image, at least one first pixel that is included in the compressed image and that is estimated to cause a reconstruction error in images corresponding to the respective wavelength bands, the images being reconstructed from the compressed image.

2. The method according to claim 1, wherein
in a case of (1),
the identifying includes identifying at least one first pixel, based on (3) encoding information used to reconstruct the images from the compressed image, in addition to the pixel values of the pixels included in the compressed.

3. The method according to claim 1, further comprising:
in a case where the at least one first pixel includes adjacent pixels, displaying the at least one first pixel in a highlighted manner.

4. The method according to claim 1, further comprising:
in a case where adjacent pixels included in the at least one first pixel include four or more pixels, displaying the at least one first pixel in a highlighted manner.

5. The method according to claim 1, further comprising:
displaying second pixels surrounding the at least one first pixel, in a highlighted manner.

6. The method according to claim 1, wherein
the identifying at least one first pixel based on (1) the pixel values of the pixels included in the compressed image includes
comparing predetermined upper and lower limits for pixel values with the pixel value of each of pixels included in the compressed image, and
identifying, from among the pixels included in the compressed image, a pixel whose pixel value exceeds the predetermined upper limit or falls below the predetermined lower limit as the at least one first pixel.

7. The method according to claim 1, further comprising:
in a case where a reconstruction error is estimated based on (1) the pixel values of the pixels included in the compressed image, providing an output recommending a user to adjust at least one of exposure time of an imaging device that has acquired the compressed image or illumination in an image capturing environment for acquiring the compressed image.

8. The method according to claim 1, further comprising:
in a case where a reconstruction error is estimated based on (1) the pixel values of the pixels included in the compressed image, outputting a signal to change at least one of exposure time of an imaging device that has acquired the compressed image or illumination output in an image capturing environment for acquiring the compressed image.

9. The method according to claim 1, wherein
the identifying at least one first pixel based on (2) the size of the structure represented by the compressed image includes
detecting an edge included in the compressed image,
comparing a size of an outline of the structure represented by the detected edge with a predetermined lower limit for the size of the outline, and
identifying, in a case where the size of the outline falls below the predetermined lower limit, the pixels of the compressed image corresponding to the structure as the at least one first pixel.

10. The method according to claim 1, further comprising:
providing, in a case where a reconstruction error is estimated based on (2) the size of the structure represented by the compressed image, an output recommending a user to change at least one of the target included in the compressed image or an image capturing region of the imaging device that acquires the compressed image.

11. The method according to claim 1, further comprising:
outputting, in a case where a reconstruction error is estimated based on (2) the size of the structure represented by the compressed image, a signal to change a zoom magnification of the imaging device that acquires the compressed image.

12. The method according to claim 2, wherein
the encoding information includes matrix elements corresponding to the respective wavelength bands, and
the identifying at least one first pixel based on (3) the encoding information in addition to the pixel values of the pixels included in the compressed image includes identifying at least one first pixel, based on the compressed image and elements obtained by averaging, across the wavelength bands, the matrix elements corresponding to the respective wavelength bands.

13. The method according to claim 2, further comprising:
providing, in a case where a reconstruction error is estimated based on (3) the encoding information in addition to the pixel values of the pixels included in the compressed image, at least one of an output indicating that an optical system included in the imaging device that has acquired the compressed image has an abnormality or an output recommending a user to perform maintenance of the imaging device.

14. The method according to claim 1, further comprising:
reconstructing the images from the compressed image in a case where a reconstruction error is not estimated based on at least one of (1) the pixel values of the pixels included in the compressed image or (2) the size of the structure represented by the compressed image.

15. The method according to claim 1, further comprising:
reconstructing the images from the compressed image in a case where the at least one first pixel is present outside a region of the target in the compressed image; and
refraining from reconstructing the images from the compressed image in a case where the at least one first pixel is present within the region of the target in the compressed image.

16. The method according to claim 1, further comprising:
extracting, in a case where the at least one first pixel is present outside a region of the target in the compressed image, a partial image from the compressed image so as to exclude the at least one first pixel; and reconstructing the images from the extracted partial image.

17. The method according to claim 1, further comprising:
in a case where the at least one first pixel is present within a region of the target or a surrounding region of the target in the compressed image, performing at least one of outputting a warning notification to a user, outputting a signal to change an imaging condition, or displaying the at least one first pixel in a highlighted manner.

18. The method according to claim 17, further comprising:
in a case where the at least one first pixel is present within the region of the target in the compressed image, performing at least one of outputting the warning notification to the user, outputting the signal to change the imaging condition, or displaying the at least one first pixel in a highlighted manner.

19. An imaging system comprising:
an imaging device that has light receiving regions whose optical response characteristics are different from each other; and
a processing circuit,
wherein the processing circuit
causes the imaging device to capture a compressed image, in which information regarding wavelength bands is compressed, and acquires the compressed image, and
identifies, based on at least one of
(1) pixel values of pixels included in the compressed image, or
(2) a size of a structure of a target represented by the compressed image, at least one first pixel that is included in the compressed image and that is estimated to cause a reconstruction error in images corresponding to the respective wavelength bands, the images being reconstructed from the compressed image.

20. The imaging system according to claim 19, wherein
in a case of (1),
the identifying includes identifying at least one first pixel, based on (3) encoding information used to reconstruct the images from the compressed image, in addition to the pixel values of the pixels included in the compressed image.
